(19) United States
(12) Patent Application Publication
(10) Pub. No.: US 2006/0279589 A1
(43) Pub. Date: Dec. 14, 2006

(54) Image processing apparatus and image forming apparatus

(76) Inventors: Kei Yasutomi, Kanagawa (JP); Hiroyuki Shibaki, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/448,004

(22) Filed: Jun. 7, 2006

(30) Foreign Application Priority Data
Jun. 8, 2005 (JP) 2005-168053
Sep. 16, 2005 (JP) 2005-271057

(51) Int. Cl. B41J 29/38

(52) U.S. Cl. 347/6

(57) ABSTRACT

An image processing apparatus is disclosed that includes a color separating apparatus for converting input image data into C,M,Y data; generating K data from the C, M, Y data; separating the K data into Bk data and Lk data; and generating C′,M′,Y′ data by conducting color conversion on any two of the C,M,Y data. Also included is a dither processing apparatus for selectively applying one of two dither matrices to one of the C′,M′,Y′ data in accordance with the color of an output image, and applying a predetermined dither matrix having a periodic structure that matches the periodic structure of one of the selectively applied dither matrices to the other two of the C′,M′,Y′ data.

### BACKGROUND OF THE INVENTION

1. Field of the Invention

The present invention relates to an image processing apparatus and an image forming apparatus.

2. Description of the Related Art

Conventionally, attaining a suitable density of a solid image is one of the important aspects for an image forming apparatus that forms images using one type of toner (one type of ink in a case of printing) for expressing the same hue (the conventional image forming apparatus is regarded to be an image forming apparatus using one type of toner for expressing the same hue since the four colors of CMYK each have a different hue). Thus, a sufficient amount of color material (pigment) is contained in the toner for attaining a suitable density of a solid image.

In a case of an apparatus forming images on paper using electrophotography (e.g. electrophotographic printer), an area coverage modulation method is used for reproducing middle tone density and high light images. The area coverage modulation method is a method for reproducing, for example, middle tone density and high light images by altering the size of the area to which toner is applied (in correspondence with the area coverage modulation method, there is a density modulation method in which images are formed by changing the density of pixels).

In area coverage modulation, the area to which toner is applied (i.e. dot size) is of a size which cannot be visually recognized as a dot. This enables an image to be expressed with a smooth transition from a high light area to a middle tone density area and further to a high density area. Since the areas to which toner is applied are of extremely small size such that they cannot be visually recognized, a person looking at the image is unable to notice the size difference amongst the areas to which toner is applied.

However, the following problems occur in a case of reproducing high light images to middle tone density images by using the area coverage modulation method with the above-described toner having a sufficient amount of color material (pigment) contained therein for attaining a suitable density of a solid image (hereinafter referred to as “dense toner”).

In a case where the dense toner is used for reproducing a high light image, it is required to substantially evenly apply a minute amount of toner to each dot. However, in order to do so, the application of toner is to be precisely controlled so that the same amount of toner can be applied to each dot. Achieving such control is difficult and toner may in some cases be unevenly applied to the dots. As a result, the density of the dots becomes uneven and the granularity from a high light image to a middle tone image is adversely affected (satisfactory granularity cannot be attained). Granularity serves as an index for indicating the degree of graininess of an image which is expected to have an even density. An image having poor granularity is seen as a low quality image since the viewer will be able to visually recognize the graininess of the image.

Therefore, in a case of forming and outputting an image that requires high granularity (e.g. natural image) by using the above-described dense toner, a satisfactory granularity cannot be attained due to the above-described reasons.

Particularly in a case where an image is formed by using an electrophotographic method (that is, forming an electrostatic latent image on a photoconductor by irradiating a laser beam onto the photoconductor and developing the electrostatic latent image by applying toner to the latent image), the processes of developing and transferring the image are difficult to perform since a minute amount of toner is to be evenly applied to a transfer target. Hence, a satisfactory granularity also cannot be attained in a case where an image is formed by the electrophotographic method.

In order to overcome one or more of the above-described problems, Japanese Laid-Open Patent Application No. 8-171252 discloses an image forming apparatus which not only uses a dense toner but also a toner having substantially the same hue as the dense toner but less coloring property than the dense toner (hereinafter referred to as “light shade toner”).

In combining the dense toner and the light shade toner, granularity can be improved by mainly using the light shade toner with respect to the transitional area between the high light area and the middle tone area. This owes to the fact that the use of light shade toner for forming a high light image enables more toner to adhere to target dot portions compared to using dense toner. In other words, the amount of toner used for obtaining a prescribed density is greater in a case of using light shade toner compared to a case of using dense toner. Since more toner is applied to each dot in such case using a light shade toner, there is no significant change of density even in a case where the applied toner is slightly scattered. As a result, an image having satisfactory granularity can be output.

In a below-described embodiment of the present invention, there is provided an image processing apparatus applicable to an image forming apparatus (e.g. multi-color image forming apparatus) using toner of five colors including Cyan (C), Magenta (M), Yellow (Y), Black (Bk) and Light shade black (Lk) for outputting an image having satisfactory granularity.

Meanwhile, image data input to an image forming apparatus for forming a gradation image (e.g. photograph), in general, comprise multi-value data of 8-12 bits per pixel. In a case of outputting the image on paper (i.e. hard copy) with an image forming apparatus such as an electrophotographic printer, the number of tones that can be reproduced for a single pixel is considerably small. In order to solve this problem, the image forming apparatus increases the resolution to, for example, 600 dpi, 1200 dpi, and modulates the image density (area-wise) by using multiple pixels. Accordingly, the image forming apparatus expresses the image with a pseudo continuous tone. This process of converting input image data to a pseudo continuous tone image is referred to as a digital half toning process (also referred to as a pseudo continuous tone process).

Next, a problem of color moire is briefly described since the below-described embodiment of the present invention relates to a problem of color moire (which sometimes occurs in a case of using a dither method as the digital half toning process).

In a case where a dither method is performed on an image, the image becomes an image having a periodic structure. Furthermore, in a case of forming a color image, the image may be formed by overlapping plural toner images (generally, overlapping toner images of Cyan (C), Magenta (M), Y (Yellow), and Black (K)). Moreover, the dither method is performed on the image data for each color, so that toner images having different periodic structures are formed.

In the past, a type of dither process for providing the same periodic structure to the image data of each color was used. However, such type of dither process is rarely used nowadays since color change tends to occur in the areas where colors are overlapped. The type of dither method that is currently mainly used is a dither method for providing different periodic structures to the image data of each of the four colors (for example, adjusting the screen angle or the number of screen lines).

In a case of using the method of overlapping four color toner images having different periodic structures, a phenomenon similar to adding two waves of different frequencies (beat) may sometimes occur. In such a case, interference patterns (referred to as “color moire”) may be observed. The interference patterns are created in low frequency areas (beat of low frequency) and are unpleasant to the user if they are visible. Furthermore, creation of such interference patterns leads to degradation of image quality. Therefore, in overlapping the four color images, combinations of a four color dither matrix are chosen and the dither matrix used for the dither process is determined from the aspect of preventing visible interference patterns as much as possible (creating color moire in high frequency). However, since there is no established method of obtaining well-balanced color moire for every color, the combinations that are currently used are those found to be satisfactory based on experience.

As an example of a dither matrix combination used by industrial printing machines, there is a method of arranging four colors of C, M, Y, and K in a manner shown in FIGS. 2 and 3. In this exemplary arrangement method, the colors are set to predetermined screen angles, in which Yellow (Y) is set to 0 degrees, Cyan (C) is set to 15 degrees, Black (K) is set to 45 degrees, and Magenta (M) is set to 75 degrees (although there are no particular limitations regarding the number of screen lines, the number of screen lines for CMYK are substantially the same and are approximately 175 lpi).

In order to reproduce the above-described screen angle, a resolution of 2400 dpi or more is desired. In a case where the resolution is less than 2400 dpi, a similar screen angle that can obtain substantially the same results as the above-described screen angle is selected (FIG. 3 shows a screen arrangement formed with a resolution of 2400 dpi in accordance with the screen angle shown in FIG. 2). In this exemplary arrangement method, the periodic structure is a square shape and the dot shape is round. Accordingly, equivalent orientation axes exist even when the screen angle for each color is shifted 90 degrees (See FIG. 2). In this exemplary arrangement method, the screen angle difference between Y and C, M is set to 15 degrees owing to the fact that color moire created between Y and C, M tends to be relatively indiscernible (in the field of printing, it is said that there is little color moire between Y and the other colors C,M, K). One related art example for resolving the problem of color moire is disclosed in Japanese Laid-Open Patent Application No. 2002-112047.

Meanwhile, as described above, granularity can be improved by forming images with use of five toner images (using light shade black (Lk) in addition to the other four colors (C, M, Y, K)). However, in this case, a combination of five colors instead of four colors is used. Accordingly, since the screen angle for each color is distributed within a predetermined angle range (90 degrees in a case of a screen, 180 degrees in a case of a line screen), the screen angle difference among respective colors becomes smaller compared to a case of forming an image with four colors. A small screen angle difference among respective colors results in creation of color moire of small spatial frequency (the periodic structures of the toner images become more recognizable).

In other words, color moire, which causes degradation of image quality, is more likely to occur in a case of forming images with five color toner images than forming images with four color toner images.

Furthermore, although inkjet printers using colors such as light shade black, light shade cyan, light shade magenta, etc., are commercially available, the inkjet printers use an error diffusion method as their digital half-toning method rather than using the dither method. The error diffusion method is one type of digital half-toning method using FM modulation. Since the error diffusion method has no periodic component, the overlapping of plural colors, theoretically, does not cause color moire. Therefore, there is no need to consider the problem of color moire for the inkjet printers.

Similar to the inkjet printers, the problem of color moire can be prevented by employing a digital half-toning method such as the error diffusion method having no periodic component for an apparatus using an electrophotographic method. However, since the apparatus using the electrophotographic method has poor reproducibility and stability for an isolated dot(s), applying the error diffusion method to the electrophotographic apparatus may adversely affect image quality (e.g. degradation of granularity, creation of irregular lines). Accordingly, it is more suitable to use the dither method as the digital half-toning method for an electrophotographic type image forming apparatus providing low dot stability. Therefore, there is a desire to apply the dither method to an image forming method (image forming method) and form five color toner images without creating color moire.

### SUMMARY OF THE INVENTION

Embodiments of the present invention provide an image processing apparatus and an image forming apparatus that solve or reduce one or more of the above problems caused by the limitations and disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by an image processing apparatus and an image forming apparatus particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides an image processing apparatus including: a color separating apparatus for converting input image data into C,M,Y data, generating K data from the C, M, Y data, separating the K data into Bk data and Lk data, and generating C′,M′,Y′ data by conducting color conversion on any two of the C,M,Y data; and a dither processing apparatus for selectively applying one of two dither matrices to one of the C′,M′,Y′ data in accordance with the color of an output image, and applying a predetermined dither matrix having a periodic structure that matches the periodic structure of one of the selectively applied dither matrices to the other two of the C′,M′,Y′ data.

Another embodiment of the present invention provides an image processing apparatus including: a color separating apparatus for converting input image data into C,M,Y data, generating K data from the C, M, Y data, separating the K data into Bk data and Lk data, and generating C′,M′,Y′ data by conducting color conversion on any two of the C,M,Y data; and a dither processing apparatus for selectively applying one of two dither matrices to one of the C′,M′,Y′ data in accordance with the color of an output image.

Another embodiment of the present invention provides an image processing apparatus including: a color separating apparatus for converting input image data into C,M,Y data, generating K data from the C, M, Y data, and generating C′,M′,Y′ data by conducting color conversion on any two of the C,M,Y data; and a dither processing apparatus for selectively applying one of two dither matrices to one of the C′,M′,Y′ data in accordance with the color of an output image, and applying a predetermined dither matrix having a periodic structure that matches the periodic structure of one of the selectively applied dither matrices to the other two of the C′,M′,Y′ data.

Another embodiment of the present invention provides an image processing apparatus including: a color separating apparatus for converting input image data into C,M,Y data, generating K data from the C, M, Y data, and generating C′,M′,Y′ data by conducting color conversion on any two of the C,M,Y data; and a dither processing apparatus for selectively applying one of two dither matrices to one of the C′,M′,Y′ data in accordance with the color of an output image.

Another embodiment of the present invention provides an image forming apparatus for forming multicolor images on a paper, the image forming apparatus including: the image processing apparatus according to an embodiment of the present invention.

Another embodiment of the present invention provides an image processing method including the steps of: a) converting input image data into C,M,Y data; b) generating K data from the C, M, Y data; c) separating the K data into Bk data and Lk data; d) generating C′,M′,Y′ data by conducting color conversion on any two of the C,M,Y data; e) selectively applying one of two dither matrices to one of the C′,M′,Y′ data in accordance with the color of an output image; and f)applying a predetermined dither matrix having a periodic structure that matches the periodic structure of one of the selectively applied dither matrices to the other two of the C′,M′,Y′ data.

Another embodiment of the present invention provides an image processing method including the steps of: a) converting input image data into C,M,Y data; b) generating K data from the C, M, Y data; c) separating the K data into Bk data and Lk data; d) generating C′,M′,Y′ data by conducting color conversion on any two of the C,M,Y data; and e) selectively applying one of two dither matrices to one of the C′,M′,Y′ data in accordance with the color of an output image.

Another embodiment of the present invention provides an image processing method including the steps of: a) converting input image data into C,M,Y data; b) generating K data from the C, M, Y data; c) generating C′,M′,Y′ data by conducting color conversion on any two of the C,M,Y data; d) selectively applying one of two dither matrices to one of the C′,M′,Y′ data in accordance with the color of an output image; and e) applying a predetermined dither matrix having a periodic structure that matches the periodic structure of one of the selectively applied dither matrices to the other two of the C′,M′,Y′ data.

Another embodiment of the present invention provides an image processing method comprising the steps of: a) converting input image data into C,M,Y data; b) generating K data from the C, M, Y data; c) generating C′,M′,Y′ data by conducting color conversion on any two of the C,M,Y data; d) selectively applying one of two dither matrices to one of the C′,M′,Y′ data in accordance with the color of an output image.

Another embodiment of the present invention provides a computer-readable medium on which a program for causing a computer to execute an image processing method is recorded, the image processing method including the steps of: a) converting input image data into C,M,Y data; b) generating K data from the C, M, Y data; c) separating the K data into Bk data and Lk data; d) generating C′,M′,Y′ data by conducting color conversion on any two of the C,M,Y data; e) selectively applying one of two dither matrices to one of the C′,M′,Y′ data in accordance with the color of an output image; and f)applying a predetermined dither matrix having a periodic structure that matches the periodic structure of one of the selectively applied dither matrices to the other two of the C′,M′,Y′ data.

Another embodiment of the present invention provides A computer-readable medium on which a program for causing a computer to execute an image processing method is recorded, the image processing method including the steps of: a) converting input image data into C,M,Y data; b) generating K data from the C, M, Y data; c) separating the K data into Bk data and Lk data; d) generating C′,M′,Y′ data by conducting color conversion on any two of the C,M,Y data; and e) selectively applying one of two dither matrices to one of the C′,M′,Y′ data in accordance with the color of an output image.

Another embodiment of the present invention provides A computer-readable medium on which a program for causing a computer to execute an image processing method is recorded, the image processing method including the steps of: a) converting input image data into C,M,Y data; b) generating K data from the C, M, Y data; c) generating C′,M′,Y′ data by conducting color conversion on any two of the C,M,Y data; d) selectively applying one of two dither matrices to one of the C′,M′,Y′ data in accordance with the color of an output image; and e) applying a predetermined dither matrix having a periodic structure that matches the periodic structure of one of the selectively applied dither matrices to the other two of the C′,M′,Y′ data.

Another embodiment of the present invention provides a computer-readable medium on which a program for causing a computer to execute an image processing method is recorded, the image processing method including the steps of: a) converting input image data into C,M,Y data; b) generating K data from the C, M, Y data; c) generating C′,M′,Y′ data by conducting color conversion on any two of the C,M,Y data; and d) selectively applying one of two dither matrices to one of the C′,M′,Y′ data in accordance with the color of an output image.

Other objects and further features of the present invention will be apparent from the following detailed description when read in conjunction with the accompanying drawings.

### BRIEF DESCRIPTION OF THE DRAWINGS

FIG. 1 is a schematic diagram showing an exemplary configuration of an image processing apparatus according to a first embodiment of the present invention;

FIG. 2 is a schematic diagram for describing the setting of the screen angles of CMYK according to a conventional printing method;

FIG. 3 is a schematic diagram showing periodic structures of dot screens according to a conventional printing method;

FIG. 4 is a schematic diagram showing an exemplary configuration of an image forming apparatus according to the first embodiment of the present invention;

FIG. 5 is a schematic diagram showing an exemplary configuration of a BG/UCR part according to the first embodiment of the present invention;

FIG. 6 shows an example of a Bk, Lk separation table according to the first embodiment of the present invention;

FIG. 7 shows another example of a Bk, Lk separation table according to the first embodiment of the present invention;

FIG. 8 is a schematic diagram showing an exemplary configuration of a color information analyzing part-according to the first embodiment of the present invention;

FIG. 9 is a schematic diagram for describing the determination operation of the color information analyzing part according to the first embodiment of the present invention;

FIG. 10 is a schematic diagram showing a Y parameter setting part according to the first embodiment of the present invention;

FIG. 11 is a schematic diagram for describing the determination operation of the Y parameter setting part according to the first embodiment of the present invention;

FIG. 12 is a schematic diagram for describing the relationship between a periodic structure and parameters (numeric values) including a main vector, a sub-vector, screen angle, a screen line number according to an embodiment of the present invention;

FIG. 13 is a schematic diagram showing periodic structures of periodic structures of dither matrices according to the first embodiment of the present invention;

FIG. 14 is a schematic diagram showing an exemplary configuration of an image processing apparatus according to a second embodiment of the present invention;

FIG. 15 is a schematic diagram showing an exemplary configuration of an image processing apparatus according to a third embodiment of the present invention;

FIG. 16 is a schematic diagram showing an exemplary configuration of a dither processing part according to the third embodiment of the present invention;

FIG. 17 is a schematic diagram showing periodic structures of periodic structures of dither matrices according to the third embodiment of the present invention;

FIG. 18 is a schematic diagram for describing the relationship between a periodic structure and parameters (numeric values) including a main vector, a sub-vector, screen angle, a screen line number in a case of a dot screen according to an embodiment of the present invention;

FIG. 19 is a schematic diagram showing an exemplary configuration of an image processing apparatus according to a fifth embodiment of the present invention;

FIG. 20 is a schematic diagram showing an exemplary configuration of a BG/UCR part according to the fifth embodiment of the present invention;

FIG. 21 is a schematic diagram showing periodic structures of periodic structures of dither matrices according to the fifth embodiment of the present invention;

FIG. 22 is a schematic diagram showing an exemplary configuration of an image processing apparatus according to a sixth embodiment of the present invention;

FIG. 23 is a schematic diagram showing an exemplary configuration of an image processing apparatus according to a seventh embodiment of the present invention;

FIG. 24 is a schematic diagram showing an exemplary configuration of a dither processing part according to the seventh embodiment of the present invention;

FIG. 25 is a schematic diagram showing periodic structures of periodic structures of dither matrices according to the eighth embodiment of the present invention; and

FIG. 26 is a schematic diagram showing an exemplary configuration of another image forming apparatus according to an embodiment of the present invention.

### DESCRIPTION OF THE PREFERRED EMBODIMENTS

In the following, embodiments of the present invention are described with reference to the accompanying drawings.

[First Embodiment]

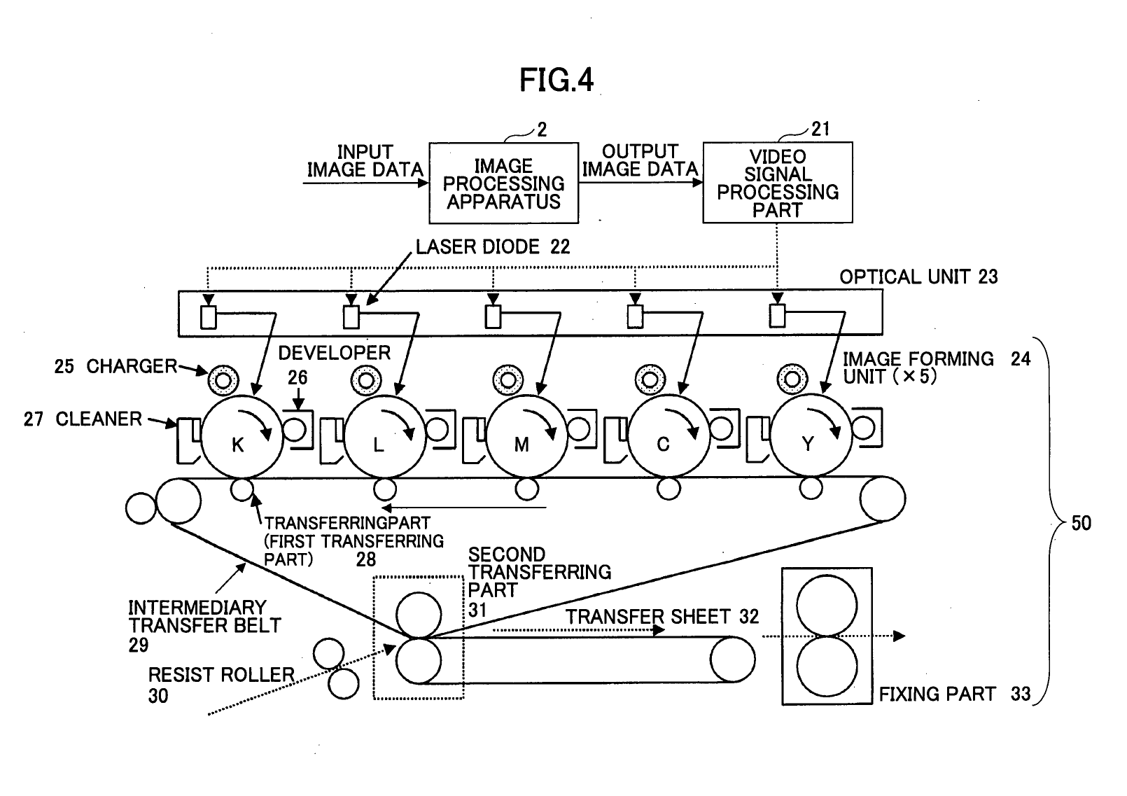

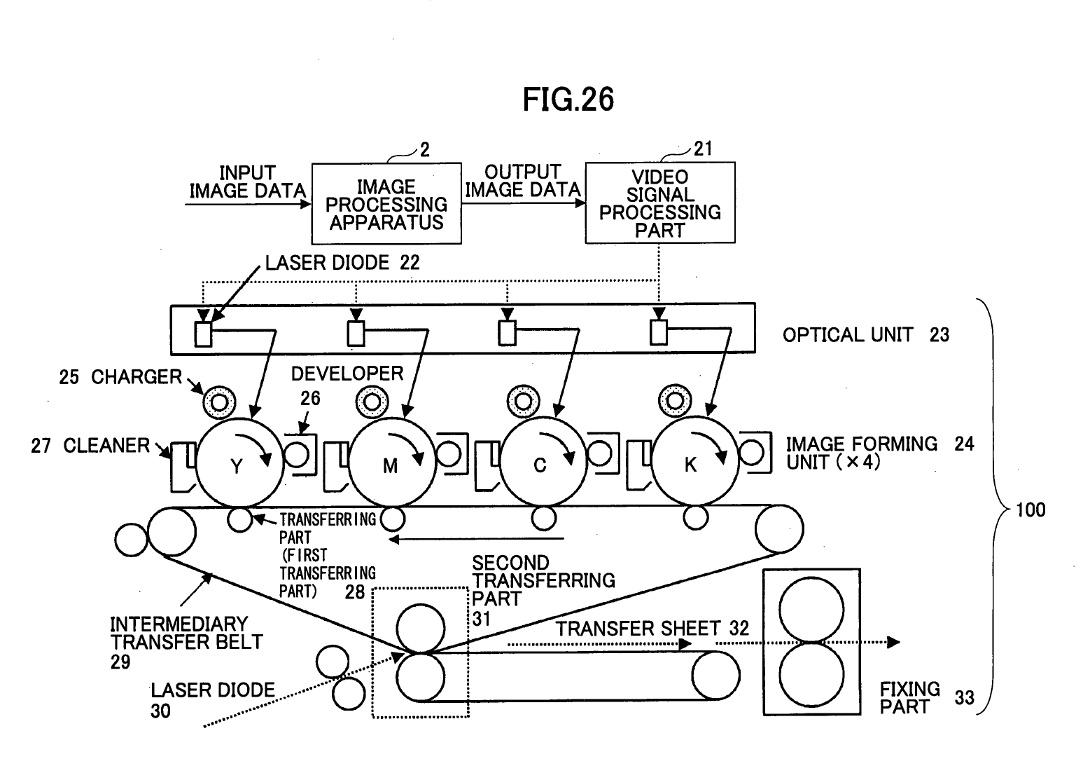

FIG. 4 shows an exemplary configuration including a multicolor image forming apparatus 50 according to the first embodiment of the present invention. The multicolor image forming apparatus 50 of the first embodiment forms color images by overlapping (superposing) images of five colors components including Cyan (C), Magenta (M), Yellow (Y), Dark Black (Bk), and Light-Shade Black (Lk) onto a sheet of paper (recording medium). FIG. 26 shows an exemplary configuration of an image forming apparatus 100 according to an embodiment of the present invention that forms color images by overlapping images of four color components including Cyan (C), Magenta (M), Yellow (Y), and Black (Bk). Since the configuration of the image forming apparatus 100 using four colors is substantially the same as that of the image forming apparatus 50 using five colors, the configuration of the image forming apparatus 50 using five colors is described below.

The image forming apparatus 50 according to the first embodiment of the present invention includes five image forming units 24 which correspond to the color components of C, M, Y, Bk, and Lk, respectively. Each of the toner images formed by the image forming units 24 is successively transferred to a belt-like intermediary transfer member (intermediary transfer belt) 29 that is mounted in a manner contacting the image forming units 24. The intermediary transfer member 29 is rotated by a driving part (not shown) at a predetermined timing. Accordingly, the toner images of each color are overlapped at a predetermined position on the intermediary transfer member 29. Then, the overlapped toner images on the intermediary transfer member 29 are transferred together to a recording sheet (transfer paper) 32 in a batch. Thereby, an image is formed on the recording sheet 32.

Since the five image forming units 24 in the image forming apparatus 50 according to the first embodiment of the present invention have the same configuration, one of the five image forming units 24 is described below. The image forming unit 24 includes a photoconductor drum, a charging part for charging the photoconductor drum to a desired potential, an optical laser unit 23 for forming a latent image on the photoconductor by writing image data onto the photoconductor in accordance with output image data (image data processed by the below-described half toning method), a developing part 26 for developing the latent image formed on the photoconductor with a toner of a corresponding color component, a transferring part (first transferring part) 28 for transferring the toner image from the photoconductor to the intermediary transfer member 29, and a cleaning part 27 for removing residual toner remaining on the photoconductor.

The recording sheet (e.g. paper) 32, which is conveyed from a sheet feed compartment (not shown) by a conveying part (not shown), is conveyed to a second transferring part 31 at a predetermined timing by resist rollers 30. The second transferring part 31 transfers the toner image of the intermediary transfer member 29 to a desired area on the recording sheet 32. Then, the recording sheet 32, which has the transferred toner image thereon, is heated and pressed by a fixing part 33. Then, the recording sheet 32 is ejected from the image forming apparatus 100. With the above-described process, a multicolor image is formed on a recording sheet in accordance with image data.

Next, an exemplary operation of an optical unit (optical laser unit) that operates in accordance with output image data (image data processed into a form for being output by an image forming apparatus) processed by the below-described image processing apparatus 2 is described with reference to FIG. 4. First, the image processing apparatus 2 performs an image process on input image data for generating output image data. Then, a video signal processing part 21 receives the output image data and stores the output image data in its line memory (memories) that correspond to the number of laser diodes (LD) 22 provided. Then, the video signal processing part 21 sends the output image data in the line memory to a PWM (pulse width modulation) control part (not shown) at a predetermined timing (pixel clock) in accordance with signals (synchronization signals) synchronizing with the rotation of a polygon mirror (not shown). In the first embodiment of the present invention, the number of laser diodes is two for each color.

The PWM control part converts the output image data to pulse width modulation (PWM) signals and sends the PWM signals to a laser diode (LD) driver (not shown) The LD driver drives the optical modulation of a laser diode (LD) element or an array of laser diode elements (laser diode array) with a predetermined quantity of light in accordance with the PWM signals from the PWM control part. In the first embodiment of the present invention, the controlling of the pulse width modulation and the driving of the optical modulation are performed in correspondence with the output image data of each color component.

The light emitted from the laser diode 22 is formed into a parallel beam by a collimator lens (not shown) and into a beam having a predetermined beam diameter by an aperture (not shown). After the beam passes through the aperture, the beam is incident on the polygon mirror via a cylindrical lens (not shown). The light beams reflected from the polygon mirror are condensed by a scanning lens (f-θ lens). Then, the condensed 1beams are deflected to a predetermined area(s) on the above-described photoconductor via a deflection mirror (not shown). Thereby, an image is formed on the photoconductor.

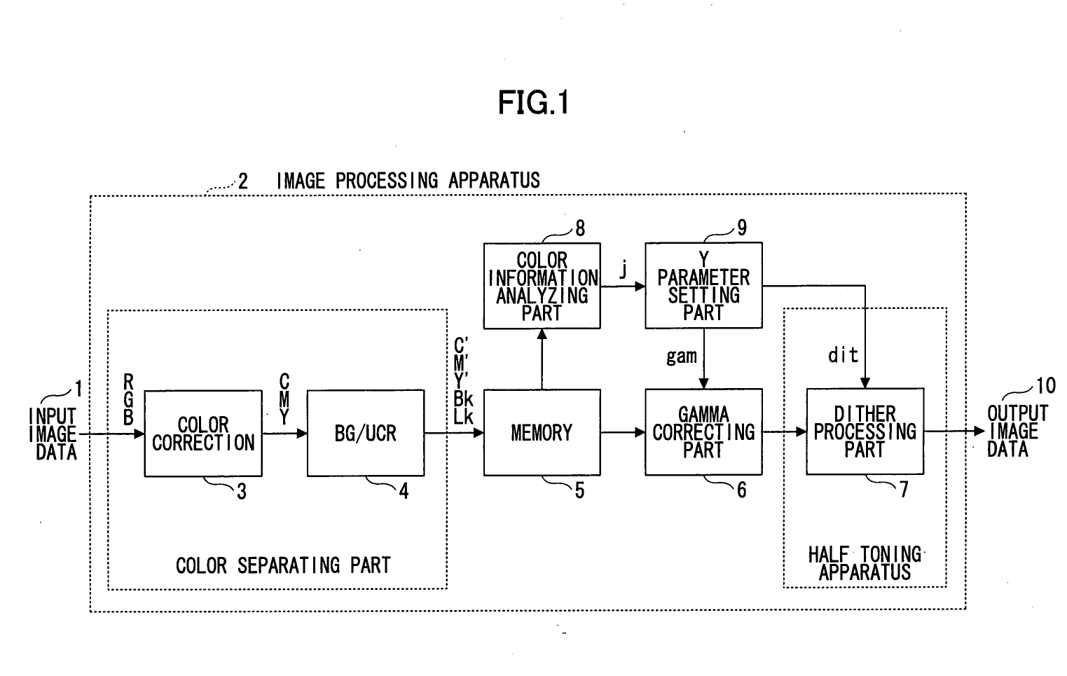

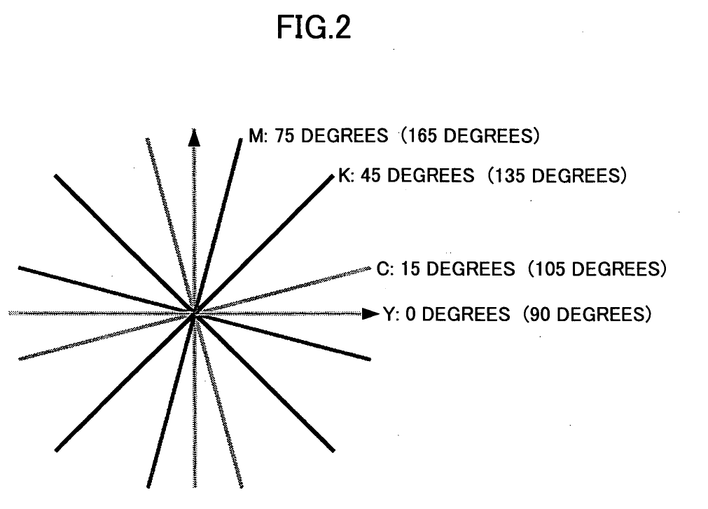

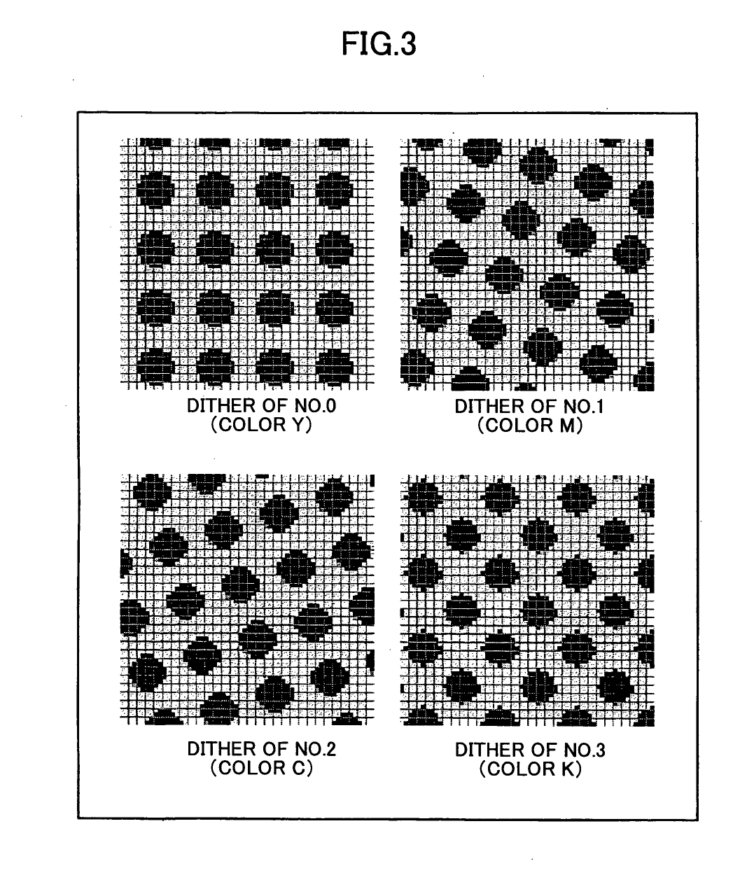

Next, the image processing apparatus 2 for processing input image data and generating output image data is described. FIG. 1 shows an exemplary configuration of the image processing apparatus 2 according to the first embodiment of the present invention. In this example shown in FIG. 1, the input image data are digital image signals. The digital image signals include, for example, 8 bit color image signals corresponding to each color of RGB. A color correcting part 3 included in the image processing apparatus 2 converts the RGB color image signals to CMY signals. The color correcting part 3 performs the below-described masking operation.
C=α11×R+α12×G+α13×B+β1
M=α21×R+α22×G+α23×B+β2
Y=α31×R+α32×G+α33×B+β3 (Formula 1)
In (Formula 1), α11 to α33 and β1 to β3 include predetermined color correction coefficients. Furthermore, the output CMY signals include 8 bit signals (0 to 255).

After performing the color correction operation, the CMY signals are sent to a BG/UCR part 4. The BG/UCR part 4 generates black color components including Bk (dark black) signals and LK (light shade black) signals and performs under color removal (UCR) in accordance with the CMY signals. FIG. 5 shows an exemplary configuration of the BG/UCR part 4. As shown in FIG. 5, CMY signals are input to a BG part (black generating part) 41 included in the BG/UCR part 4. In accordance with the input CMY signals, the BG part 41 generates K signals. The K signals are generated by the below-described (Formula 2).
K=Min (C,M,Y)×β4 (Formula 2)
In (Formula 2), Min (C,M,Y) indicates the least signal of the CMY signals, and β4 includes a predetermined coefficient.

Furthermore, a UCR part (under color removing part) 42 included in the BG/UCR part 4 obtains C′,M′,Y′ signals (C,M,Y signals from which a black color component subtracted) with the below-described (Formula 3) based on the C,M,Y signals and the K signals generated by the BG part 41.
C′=C−K/β4
M′=M−K/β4
Y′=Y−K/β4 (Formula 3)

As shown in Formulas 2 and 3, the BG/UCR part 4 according to the first embodiment of the present invention generate the C′,M′,Y′ signals so that at least one of the signals C′, M′ and Y′ becomes 0.

Although the conversion to CMYK signals (conversion to C′,M′,Y′, K signals) is performed by masking with the color correcting part 3 and performing black generation and under color removal with the BG/UCR part 4 according to the first embodiment of the present invention, the color conversion may also be performed by employing a DLUT (Direct Look-Up Table). In the case of employing the DLUT, the CMYK conversion is to be performed so that at least one of C, M, Y becomes 0. In other words, the color conversion is to be performed so that the three components of C′, M′, Y′ cannot be used simultaneously with respect to a single pixel.

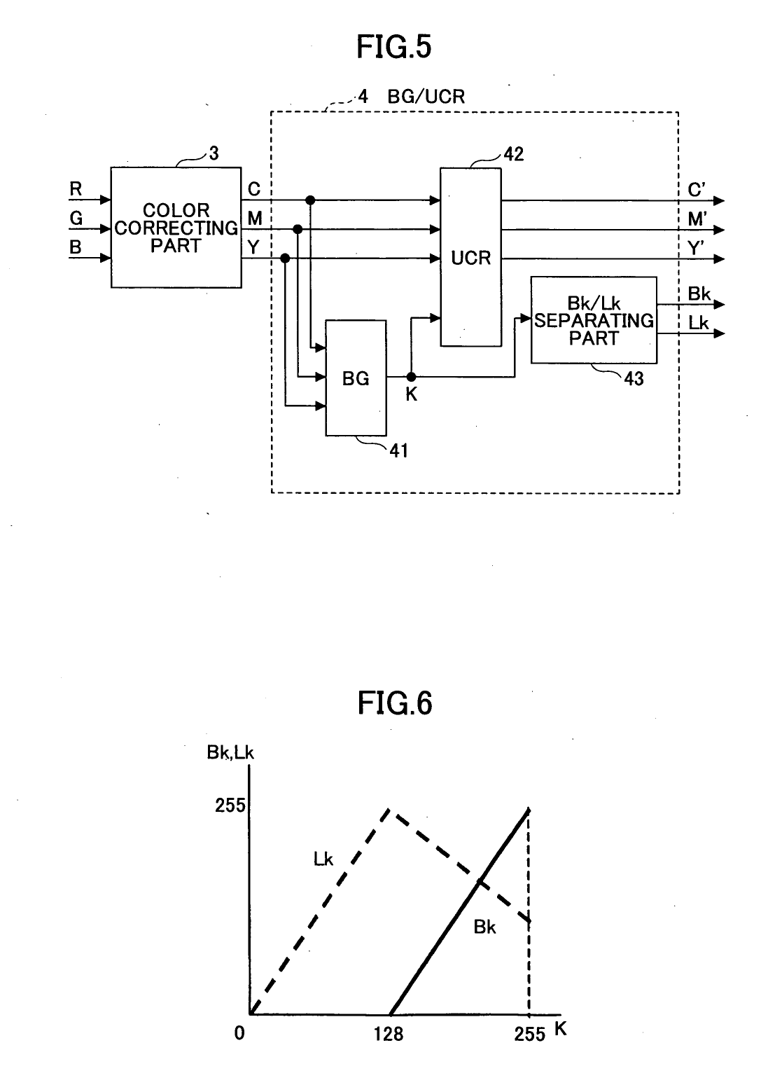

Furthermore, the K signals of the C′,M′,Y′,K signals generated by the above-described method are sent to a Bk/Lk separating part 43. The Bk/Lk separating part 43 separates the input K signals into Bk signals and Lk signals. FIG. 6 shows an example of a separation table used for separating the K signals into Bk signals and Lk signals. In FIG. 6, the value of Lk gradually increases as the value of K increases in the range between 0 to 128 and saturates when the value of K reaches 128. As the value of K further increases from 128, the value of Lk decreases. Meanwhile, the value of Bk gradually increases as the value of K increases from 128. In a case where K=255, the output value of Lk is 128 (Lk=128) and the output value of Bk is 255 (Bk=255). Accordingly, the Bk/Lk separating part 43 is configured to separate the K signals into Lk signals and Bk signals by using the above-described separation table.

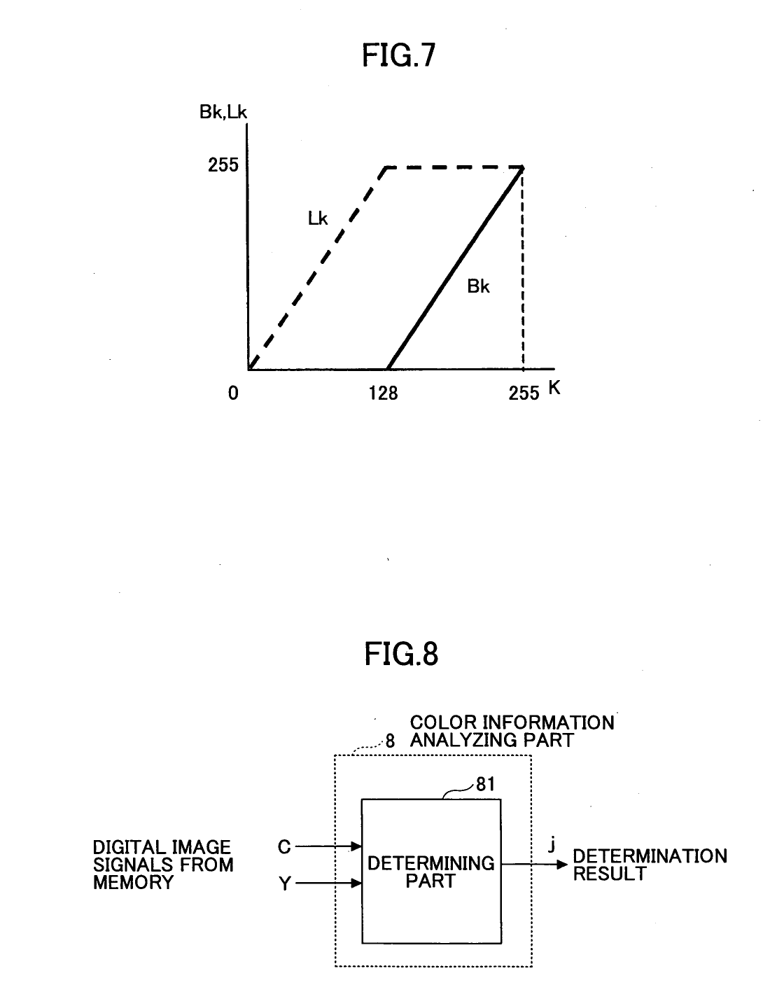

It is to be noted that other separation tables besides the separation table shown in FIG. 6 may alternatively be used. For example, the separation table shown in FIG. 7 may also be used.

As shown in FIG. 1, the image signals corresponding to each of the five colors (C′,M′,Y′,Bk, Lk) output from the BG/UCR part 4 are temporarily stored in a memory 5. The image signals stored in the memory 5 are output to a color information analyzing part 8 for determining a parameter suitable for subsequent processes performed by the below-described γ correcting part (printer γ correcting part) 6 and a dither processing part (digital halftone processing part) 7.

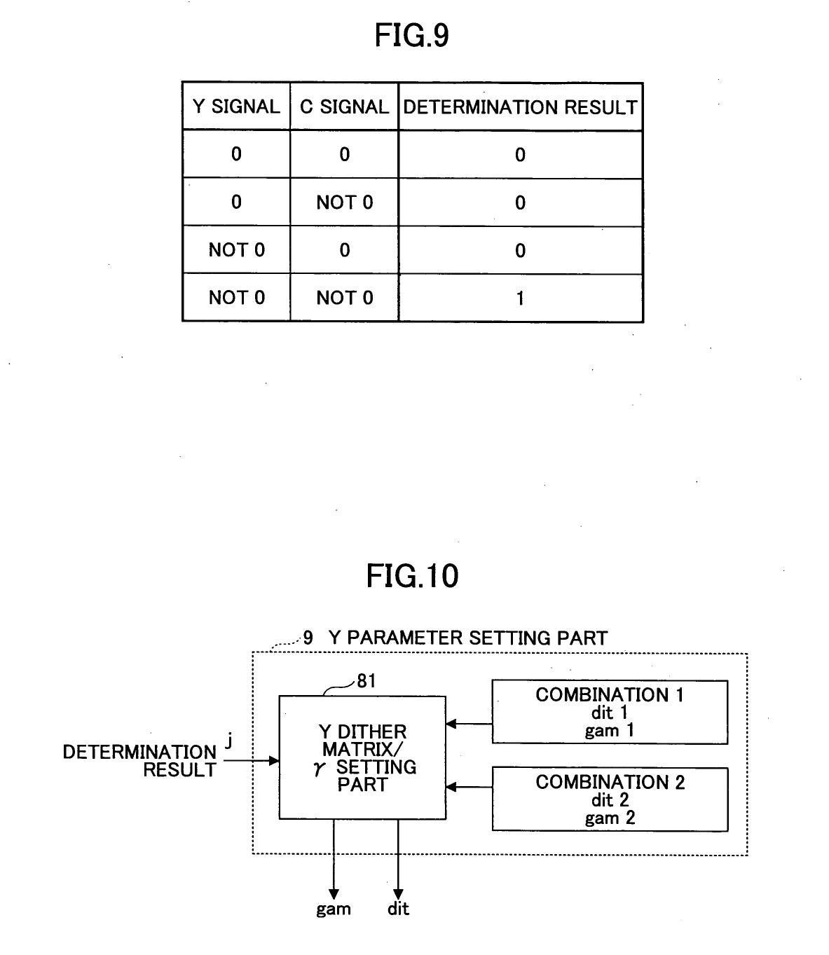

Next, the color information analyzing part 8 is described with reference to FIG. 8. The color information analyzing part 8 obtains a Y signal and a C signal with respect to each pixel from the image signals stored in the memory 5 and outputs a determination result (determination result signal). The color information analyzing part 8 determines whether the values of both the Y signal and the C signal are values other than 0 (i.e. a value that is not 0) and outputs a j signal having a value corresponding to the result of the determination. FIG. 9 is a table for describing the determination operation of the color information analyzing part 8. In a case where the values of both the Y signal and the C signal are other than 0, the color information analyzing part 8 outputs a j signal having a value of 1. In a case where the value of either or both the Y signal and the C signal are 0, the color information analyzing part 8 outputs a j signal having a value of 0.

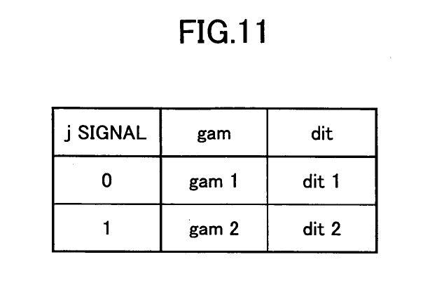

When the below-described Y parameter setting part 9 receives a j signal output from the color information analyzing part 8, the Y parameter setting part 9 sets Y parameters to the γ correcting part 6 and the dither processing part 7 in accordance with the received j signal (see FIG. 10). As shown in FIG. 10, the Y parameters, which are set to the γ correcting part 6 and the dither processing part 7 in accordance with the determination result, are obtained from the two parameter combinations (parameter sets) being stored beforehand in the Y parameter setting part 9. In this example, the Y parameters include a dither matrix and a γ table (printer γ table). The dither matrix is used by the dither processing part (half toning apparatus) 7 for performing a dither process on the Y signal. The dither matrix includes, for example, a first dither matrix (dit 1) and a second dither matrix (dit 2). Furthermore, the γ table is a single dimensional LUT (Look-Up Table) including a first LUT (gam 1) and a second LUT (gam 2). The first LUT (gam 1) is a suitable LUT in a case where the first dither matrix (dit 1) is used on the Y signal. The second LUT (gam 2) is a suitable LUT in a case where the second dither matrix (dit 2) is used on the Y signal. Accordingly, the two types of LUTs are selectively used in combination with the dither matrices according to value of the j signal (determination result). That is, the dither matrices and the γ tables are to be used in combination in accordance with the j signal (determination result). FIG. 11 is a table for describing the operation of the Y parameter setting part 9 according to the first embodiment of the present invention.

Since the color information analyzing part 8 and the Y parameter setting part 9 operate in correspondence with each pixel, one of the two parameter combinations including the γ table and the dither matrix is selected and applied to each pixel in accordance with the determination result. Meanwhile, since the operation of selectively applying the γ table and the dither matrix is not performed with respect to the other remaining four colors of C, M, Bk, and Lk, the γ correction process and the dither process (half toning process) for the remaining four colors (C, M, Bk, Lk) are performed by applying predetermined γ tables and dither matrices (dither process) corresponding to the remaining four colors (C, M, Bk, Lk).

Then, after the γ correction process and the half toning process are completed, output image data 10 are output from the image processing apparatus 2 to the image forming apparatus 50 via the optical laser unit 23. Thereby, a hard copy image of the output image data 10 is formed on the recording sheet 32.

Although the above-described operation of selectively applying the dither matrices is performed on color Y (Yellow), the operation may alternatively be performed on colors such as C (Cyan) or M (Magenta).

Next, the dither process (dither matrix) according to the first embodiment of the present invention is described in further detail. After the above-described dithering process is performed on an image, the resultant dithered image has a linear periodic structure. That is, a dither matrix referred to as line screen dither is used in the dithering process. The numerical values (parameters) which characterize the periodic structure of the dither matrix are, for example, the screen angle and/or the screen line number.

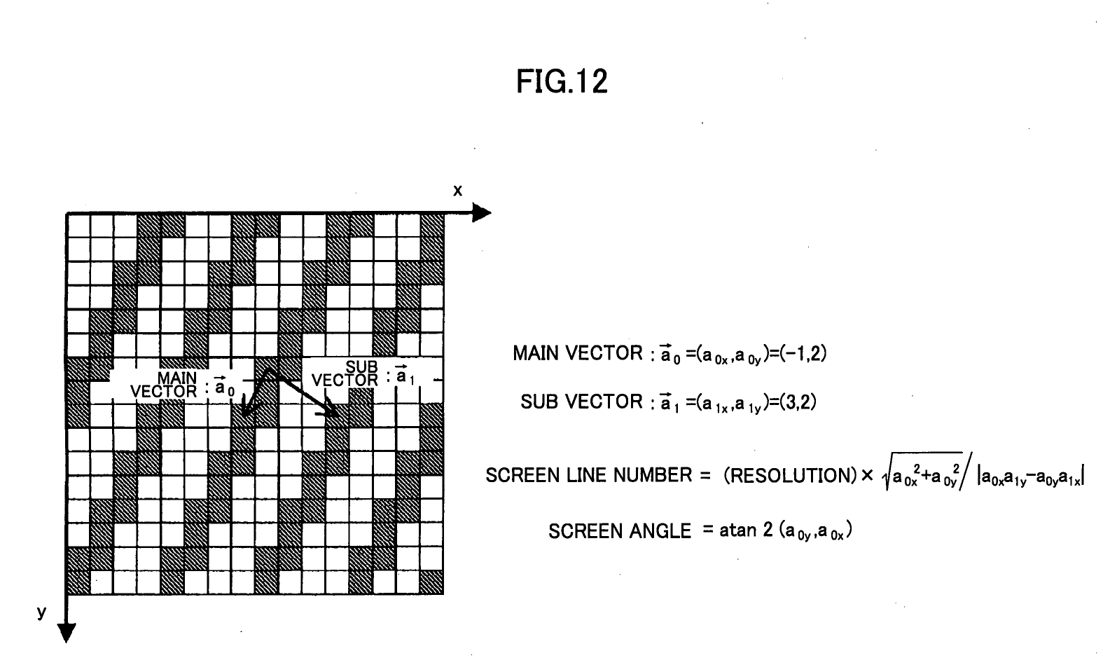

In one example where the dither matrix has a periodic structure shown in FIG. 12, the screen angle and the screen line number (number of lines per inch, lpi) are uniquely obtained from the computation formula shown in FIG. 12. A two dimensional periodic structure is typically expressed by using two two-dimensional vectors. The two vectors are hereinafter referred to as a main vector and a sub-vector.

Table 1 shows a combination of dither matrices (for five colors Y, C, M, Bk, Lk) according to the first embodiment of the present invention in a case where the main vector and the sub-vector shown in FIG. 12 are used.

TABLE 1

| | lines per | angle | | | | |
|---|---|---|---|---|---|---|
| | inch (lpi) | (deg.) | a0x | a0y | a1x | a1y |
| Y(dit1) | 191.7 | 153.43 | −2 | 1 | 1 | 3 |
| Y(dit2) | 191.7 | 116.57 | −1 | 2 | 3 | 1 |
| C | 191.7 | 153.43 | −2 | 1 | 1 | 3 |
| M | 191.7 | 116.57 | −1 | 2 | 3 | 1 |
| Lk | 191.7 | 26.57 | 2 | 1 | 1 | −3 |
| Bk | 191.7 | 63.43 | 1 | 2 | 3 | −1 |

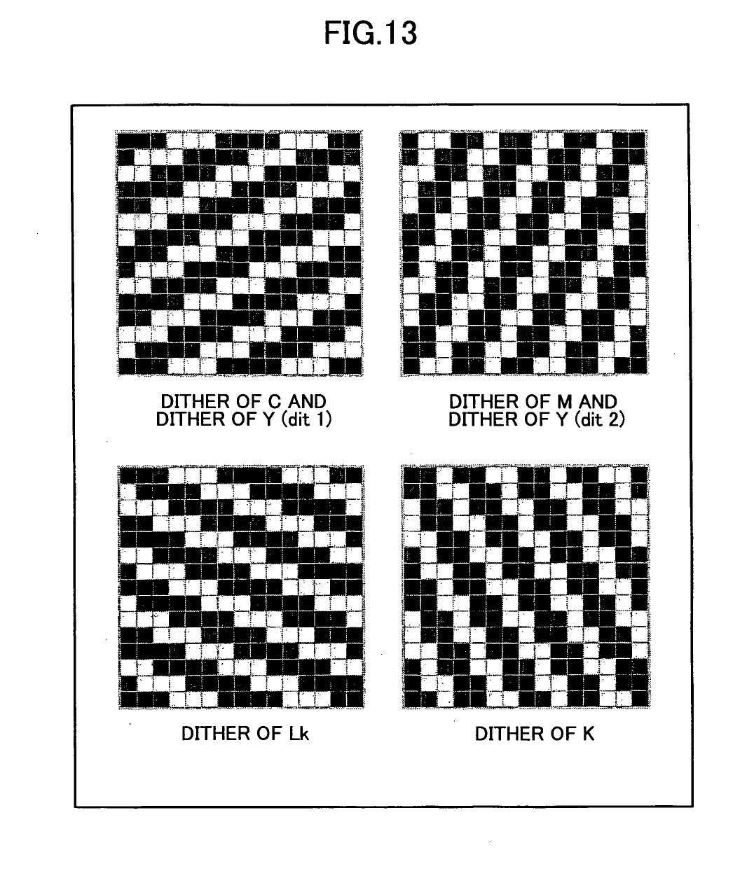

The four integers of a0x, a0y, a1x, and a1y shown in Table 1 correspond to the x component of the main vector, the y component of the main vector, the x component of the sub-vector, and the y component of the sub-vector, respectively, FIG. 12. Since the resolution is 600 dpi in the first embodiment of the present invention, it can be understood that the number of lines shown in Table 1 can be provided by obtaining the periodic structure indicated in Table 1. FIG. 13 shows the actual periodic structures of the dither matrices of Table 1. As shown in Table 1, the two types of dither matrices (dit 1, dit 2) for Y according to the first embodiment of the present invention are set so that their screen line number (lpi) and screen angle match with those of the dither matrices for C and M.

The combination of dither matrices is not limited to that shown in Table 1. As long as the screen line number and the screen angle of the two dither matrices (dit1 and dit2) for Y match with those of the dither matrices for C and M, combinations of dither matrices other than that of Table 1 may also be used.

After the above-described dithering process is performed on the image data, the image data become 4 bit dither matrices comprising 4 bits (16 values). The 4 bit dither matrix converts each pixel of input image data (8 bit data expressed in 256 levels (0-255)) to output image data (expressed in 16 levels (0-15)). In the conversion, the level (0-15) of each pixel of the input image data is determined by comparing the gradation level of each pixel of the input image data (256 levels) and a threshold level that is set beforehand with respect to the above-described 16 levels. In other words, the 4 bit dither matrix comprises 15 matrices with a predetermined threshold. For example, a method for calculating output image data with a dithering method is disclosed in Japanese Laid-Open Patent Application No. 2000-299783.

In the first embodiment of the present invention, although the quantization value in the above-described dithering process is 4 bits (16 values), other quantization values may alternatively be employed, for example, 1 bit, 2 bits, or 8 bits. Furthermore, the quantization values may also be 3 values or 5 values. The effects attained are substantially the same even in cases where different quantization values are used.

[Second Embodiment]

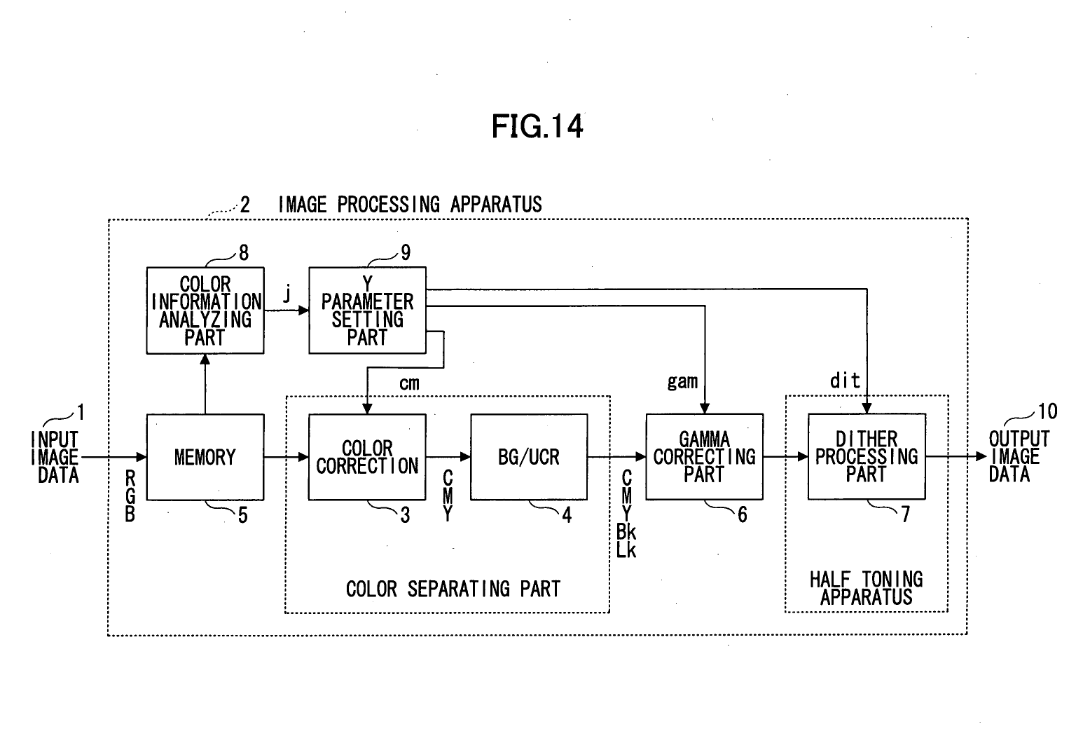

FIG. 14 shows an exemplary configuration of an image processing apparatus according to the second embodiment of the present invention. Through the descriptions and drawings of the second embodiment of the present invention, like components are denoted by like reference numerals as of the first embodiment and are not further explained. In the first embodiment, the color information analyzing process is performed on image signals after the image signals are subjected to the BG/UCR process (Black Generating Process/Under Color Removing Process). That is, the color information analyzing process is performed based on color separated image signals (C, M, Y, K, Bk, Lk). Meanwhile, in the second embodiment, the color information analyzing process is performed on image signals before the image signals are subjected to the color correcting process and the BG/UCR process (Black Generating Process/Under Color Removing Process).

As shown in FIG. 14, the color correction part (color correction circuit) 3 and the BG/UCR part (BG/UCR circuit) 4 in the second embodiment are in a position following the color information analyzing part 8. The configurations of the color correction part 3 and the BG/UCR part 4 are the same as those shown in FIG. 1. The color information analyzing part 8 of the second embodiment also outputs determination results (j signals) in correspondence with C signals and Y signals.

In accordance with the j signals received from the color information analyzing part 8, the Y parameter setting part 9 outputs a color correction parameter cm for the color correcting part 3, a γ table gam for the γ correcting part 6, and a dither matrix dit for the dither processing part 7.

With the configuration of the first embodiment, colors that are different-from those expected by the user are sometimes reproduced due to the switching process of the dither matrix for Y. However, with the configuration of the second embodiment, the color correction parameter cm of the color correcting part 3 can also be changed by the dither parameter set by the parameter setting part 9 according to the second embodiment. Therefore, an image can be created with satisfactory color reproduction performance even in a case where the dither screen is switched.

[Third Embodiment]

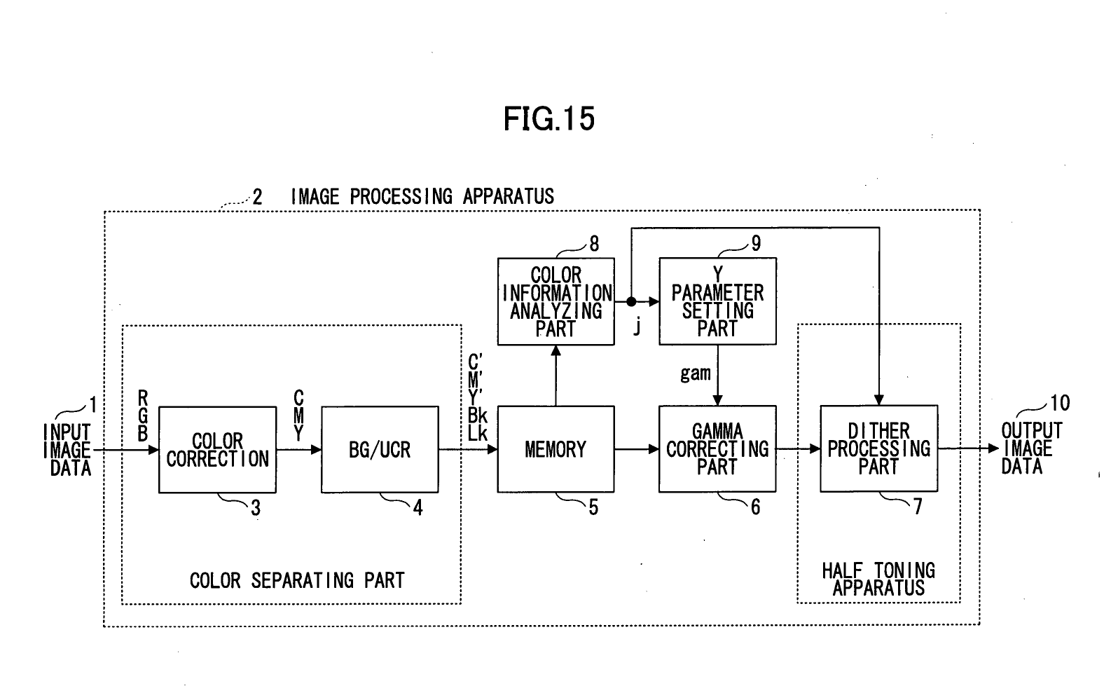

FIG. 15 shows an exemplary configuration of an image processing apparatus according to the third embodiment of the present invention. Most parts of the configuration of the third embodiment are the same as those of the first embodiment. Throughout the descriptions and drawings of the third embodiment of the present invention, like components are denoted by like reference numerals as of the first embodiment and are not further explained. The configuration of the third embodiment is different from the configuration of the first embodiment in that the dither processing part 7 receives the determination results (j signals) directly from the color information analyzing part 8 and switches the dither matrix used for Y to a dither matrix used for C or M (See FIG. 15).

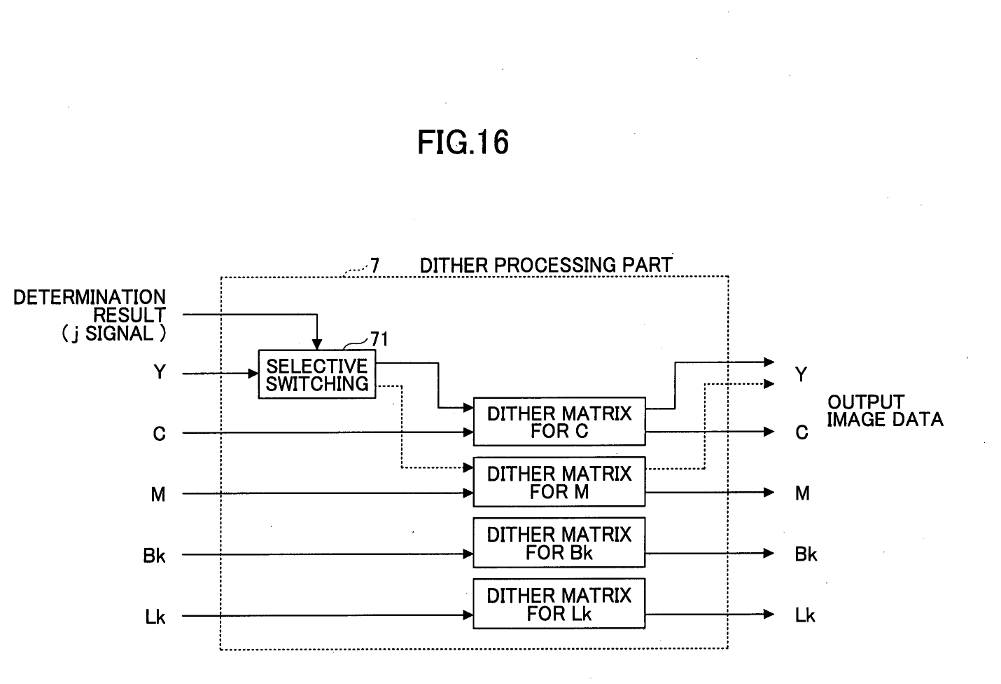

FIG. 16 is a schematic diagram showing a dither processing part 7 according to the third embodiment of the present invention. The dither processing part 7 is configured to switch the dither matrix to be applied to a Y signal. In a case where the value of the j signal is 1 (i.e. a case where both the values of both the Y signal and the C signal are other than 0), the dither matrix used for M is applied to the Y signal. In a case where the value of the j signal is 0 (i.e. a case where either one or both of the Y signal and the C signal are 0), the dither matrix used for C is applied to the Y signal.

Since the configuration of the third embodiment uses no dither matrix dedicated for the Y signal, the memory space for storing the dither matrix dedicated for the Y signal is unnecessary. Therefore, the cost for memory space can be reduced.

[Fourth Embodiment]

Although a line screen dithering process employing a linear periodic structure is used as the dithering process of the first embodiment of the present invention, a dot screen dither process employing a dot-like periodic structure is used as the dither process of the fourth embodiment of the present invention.

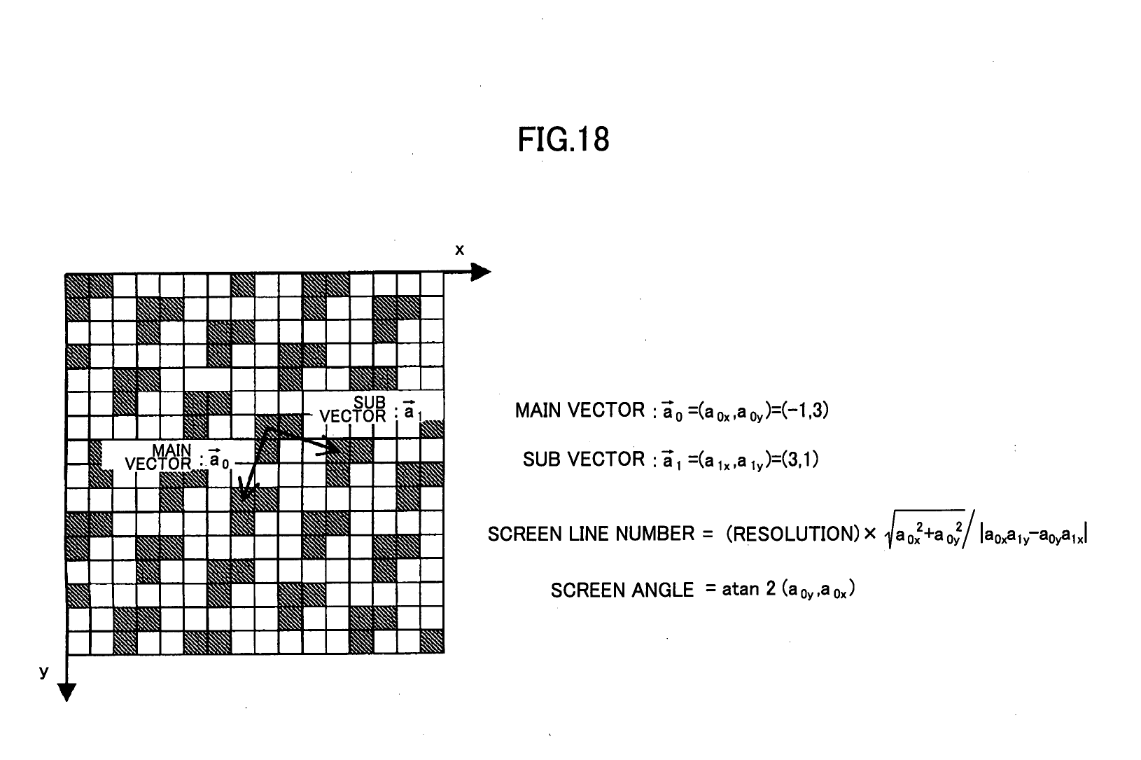

Table 2 shows a combination of dither matrices (for five colors Y, C, M, Bk, Lk) according to the fourth embodiment of the present invention in a case where the main vector and the sub-vector shown in FIG. 18 are used.

TABLE 2

| | lines per | angle | | | | |
|---|---|---|---|---|---|---|
| | inch (lpi) | (deg.) | a0x | a0y | A1x | a1y |
| Y(dit1) | 189.7 | 18.43 | 3 | 1 | 1 | −3 |
| Y(dit2) | 189.7 | 71.57 | 1 | 3 | 3 | −1 |
| C | 189.7 | 18.43 | 3 | 1 | 1 | −3 |
| M | 189.7 | 71.57 | 1 | 3 | 3 | −1 |
| Lk | 200 | 0 | 3 | 0 | 0 | −3 |
| Bk | 212.1 | 45 | 2 | 2 | 2 | −2 |

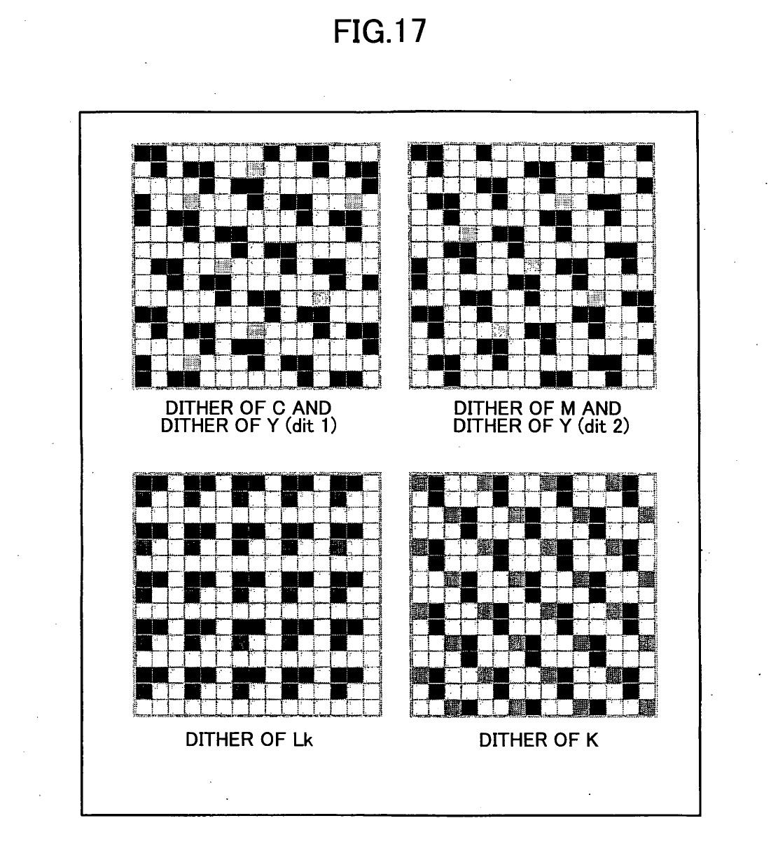

FIG. 17 shows the dither patterns corresponding to Table 2 according to the fourth embodiment of the present invention. The same as the line screen dithering process, the dot screen dithering process can express a periodic structure of dither by using periodic vectors (main vector, sub-vector). The relationship between the periodic vectors, the screen line number, and the screen angle is shown in FIG. 18.

The below-described fifth-ninth embodiments of the present invention describe an image forming apparatus using four color toners of Cyan (C), Magenta (M), Yellow (Y), and Black (K).

Although the above-described Japanese Laid-Patent Application No. 2002-112047 discloses a method of eliminating color moire, the disclosed method is still insufficient. In the method shown in Japanese Laid-Patent Application No. 2002-112047, “color change due to deviation of color overlapping position” may not be solved in a case of setting the screen that becomes the same periodic structure by employing a period structure of a different phase.

Due to “color change due to deviation of color overlapping position”, the periodic structures of the screens of respective colors (C,M,Y,K) are set to become different from each other. However, since a predetermined angle (90 degrees for a dot screen, 180 degrees for a line screen) is to be divided by the number of colors (four in a case of C,M,Y,K) for setting the screen angle of each color, there is a fixed upper limit in the screen angle difference that can be set. When difference of screen angle among colors becomes smaller, color moire of small spatial frequency (large periods being more visible) is generated. In a case of a CMYK outputting system using four colors with the conventional method, color moire of an output image is not sufficiently eliminated and is still recognizable. Color moire is considerably recognizable particularly in a case where the screens for CMYK are configured using a dot screen, in which the average screen angle difference among the colors is 22.5 degrees (=90/4). Depending on the combination, color moire is considerably recognizable since the screen angle difference is 22.5 degrees or less. Furthermore, in a case where a low resolution is used (e.g. 600 dpi), the selectable screen angle is limited. In a case where the screen angle less than the average of 22.5 degrees, the generation of color moire further increases. Therefore, a new method for eliminating color moire is desired. Meanwhile, in a case where a line screen is used as the screens for CMYK, color moire is less recognizable compared to using a dot screen since the spatial frequency of color moire becomes larger. Even in this case, however, color moire cannot be completely eliminated. Although the use of a line screen is effective in eliminating color moire, the line screen has insufficient gradation stability and is susceptible to dot gain.

Hence, according to a below-described embodiment of the present invention there is provided a method of reproducing high quality images without experiencing color moire.

A half-toning method of a commercially available inkjet printer does not use a dither method but uses an error diffusion method for reproducing images. The error diffusion method is a half-toning process using FM modulation. Accordingly, the error diffusion method, theoretically, does not experience color moire due to overlapped color since the error diffusion method has no periodic component. That is, there is no need to consider the problem of color moire in a case of an inkjet printer using the error diffusion method. Likewise, an electrophotographic type apparatus can also avoid the problem of color moire by using a half-toning method having no periodic attribute such as the error diffusion method. However, the error diffusion method is relatively difficult to apply to the electrophotographic type apparatus since the electrophotographic type apparatus has poor reproducibility and stability of an isolated dot (spot). An electrophotographic type printer having such poor isolated dot reproducibility/stability will form an image having degraded granularity or linear unevenness in a case where the printer uses an error diffusion method. Therefore, the dither method is the half-toning method that is suited for the electrophotographic type printer having low dot stability. It is, therefore, desired to provide an electrophotographic type printer using the dither method while avoiding the problem of color moire.

Hence, according to the below-described embodiment of the present invention there is provided an electrophotographic type apparatus (image forming apparatus) that reproduces high quality images without experiencing color moire.

Meanwhile, in an electrophotographic type image forming apparatus using a powder toner, color moire between the color Y and the other three colors CMK is significantly recognizable compared to other image forming apparatuses such as a printing apparatus or an inkjet printer. That is, although hardly any color moire between-the color Y and the other three colors CMK is generated by a printing apparatus or an inkjet printer, such color moire can be found in a case of using an electrophotographic type image forming apparatus. Japanese Laid-Open Patent Application No. 2001-34024 discloses the color moire problem of the electrophotographic type image forming apparatus and teaches that the toner image that is overlapped afterward causes scattering of toner. Accordingly, Japanese Laid-Open Patent Application No. 2001-34024 discloses a method of preventing such method by setting the order of overlapping the toner images of CMYK so that the Y color image is the last image to be overlapped.

Nevertheless, in a case of using an image forming method using a powder toner, color moire may still occur for a Y color image. Therefore, it is difficult to apply the CMYK screen setting method to a widely used industrial-purpose printing apparatus. That is, it is difficult to set the screen angle difference to 15 degrees between Y and C (or M) in a case of an electrophotographic type image forming apparatus using powder toner given that color moire is significantly recognizable. Accordingly, in a case of an electrophotographic type image forming apparatus using powder toner, there is a desire for a screen setting method that can be applied to all four colors of CMYK without experiencing color moire.

Meanwhile, the method disclosed in Japanese Laid-Open Patent Application No. 2001-34024 (method of setting the overlapping order for preventing color moire) has poor color reproducibility. In superposing toner images on a sheet of paper, the transparency of a toner image is desired to become higher as the position of a superposed toner image becomes higher. This is due to the fact that, in a case where a toner image having low transparency is positioned at an upper toner layer, the toner image causes incident light to scatter at its surface and prevents the light from being absorbed. As a result, satisfactory color reproducibility cannot be achieved. In the method disclosed in Japanese Laid-Open Patent Application No. 2001-34024, the order for superposing toner images cannot be selected with regard to the transparency of the toner images since the order for superposing the toner image is fixed. In other words, the disclosed method cannot broaden its color reproduction range by determining the order of superposing the toner images in accordance with the transparency of the toner images. As a result, the disclosed method has a small color reproduction range.

Hence, in the below-described embodiment of the present invention is provided an image forming apparatus and image forming method that are able to prevent color moire caused by Y color and increase color reproduction range in a case of using a powder toner for image formation.

Furthermore, the inventor(s) of the present invention has found that there is a difference in the degree of color moire between the color Y and the other three colors CMK depending on the manufacturing method of the toner being used. Although described in further detail below, color moire resulting from color Y is greater in a case where toner is manufactured by using a polymerization method compared to using a grinding method. The method of manufacturing toner by using the polymerization method has the advantages of easiness in forming toner having small volume grain size (a factor that affects image quality) compared to using the grinding method and consuming less energy in the toner manufacturing process. Accordingly, the method of manufacturing toner by using the polymerization method is often used from the aspects of attaining high quality images and consuming less energy. The method of manufacturing toner by using the polymerization method has yet to resolve the problem of color moire being greater compared to using the grinding method.

Although the cause for color moire being greater when using the polymerization method is unknown, the most significant difference between the toner manufacturing method using the polymerization method and the toner manufacturing method using the grinding method is that the toner particles manufactured by the polymerization method have spherical shapes. It is assumed that, in a case where toner particles are formed having spherical shapes, the Y color toner image affects the transfer process by causing the positions of the toner images corresponding to the other remaining colors (CMK) to change. Accordingly, the toner images of CMK that are formed on a transfer member before a Y toner image is superposed thereon have their area ratio changed (becoming larger due to the Y toner image). Thus, color moire due to Y color becomes greater.

In a case where all gray components are reproduced by using K color toner, granularity may be degraded even though the generation of color moire is prevented. Therefore, according to an aspect of the present invention, there is provided an image forming apparatus (multicolor image forming apparatus) that prevents color moire without degrading of granularity.

[Fifth Embodiment]

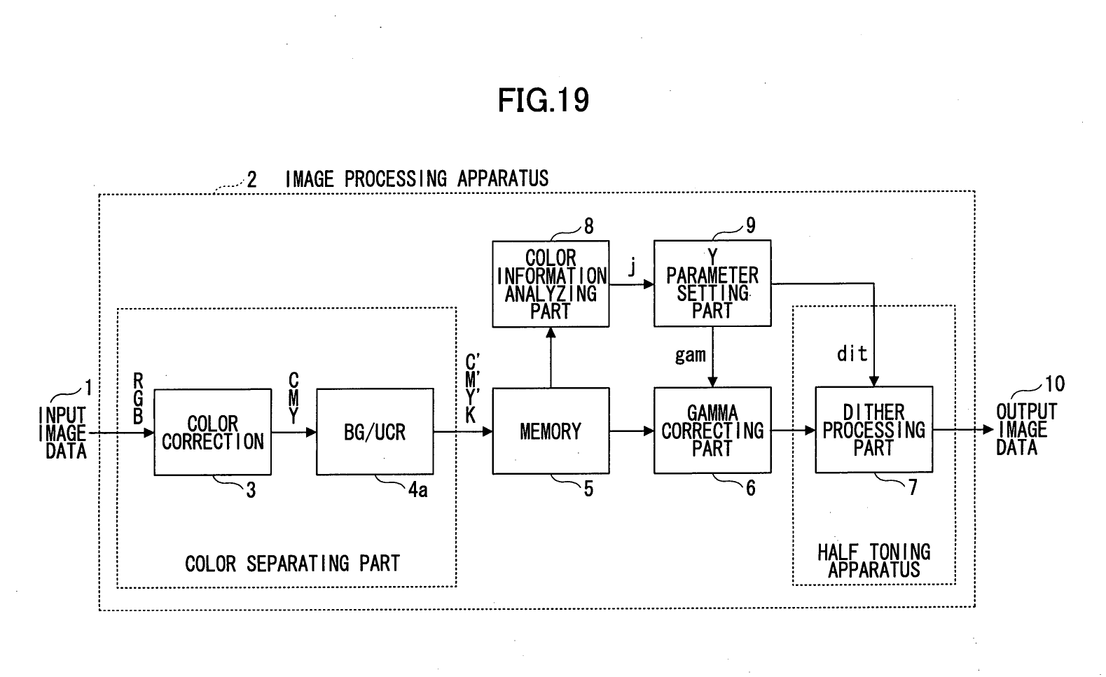

FIG. 19 is a schematic diagram showing an image processing apparatus according to the fifth embodiment of the present invention. In FIG. 19, like components are denoted by like numerals as in the above-described embodiments of the present invention and are not further explained. In FIG. 19, the input image data (digital image signals) 1 in the fifth embodiment are 8 bit color image signals corresponding to each color of RGB. The color correcting part 3 of the image processing apparatus 2 converts the color image signals of RGB to color image signals of CMY. Furthermore, the color correcting part 3 uses the masking operation shown in the Formula (1) described in the first embodiment of the present invention.

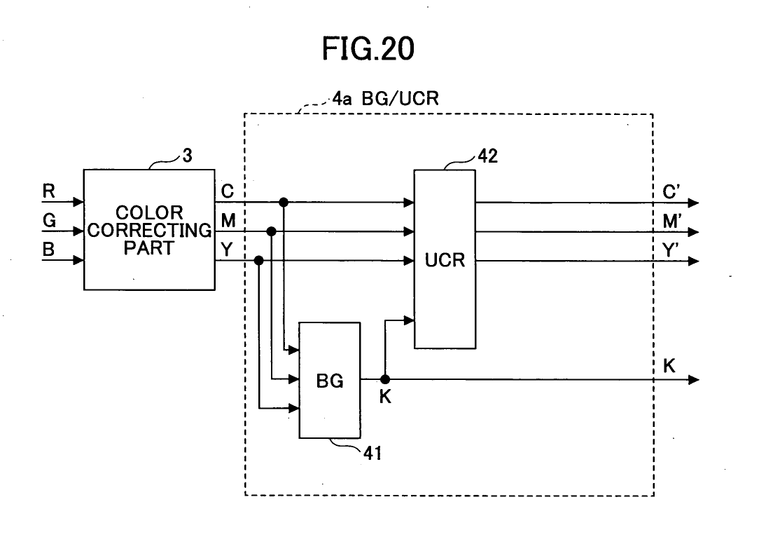

After performing the color correction operation, the CMY signals are sent to a BG/UCR part 4a. The BG/UCR part 4a generates black color components including K signals and performs under color removal (UCR) in accordance with the CMY signals. FIG. 20 shows an exemplary configuration of the BG/UCR part 4a. The BG part 41 included in the BG/UCR part 4a generates K signals by using the above-described Formula 2. Furthermore, the UCR part 42 included in the BG/UCR part 4a obtains C′,M′,Y′ signals (C,M,Y signals from which a black color component is subtracted) with the above-described Formula 3 based on the C,M,Y signals and the K signals generated by the BG part 41.

As shown in Formulas 2 and 3, the BG/UCR part 4a according to the fifth embodiment of the present invention generates the C′,M′,Y′ signals so that at least one of the signals C′, M′ and Y′ becomes 0.

Although the conversion to CMYK signals (conversion to C′,M′,Y′, K signals) is performed by masking with the color correcting part 3 and performing black generation and under color removal with the BG/UCR part 4a according to the fifth embodiment of the present invention, the color conversion may also be performed by employing a DLUT (Direct Look-Up Table). In the case of employing the DLUT, the CMYK conversion is performed so that at least one of C, M, Y becomes 0. In other words, the color conversion is performed so that the three components of C′, M′, Y′ cannot be used simultaneously with respect to a single pixel.

As shown in FIG. 19, the image signals corresponding to each of the four colors (C′, M′, Y′, K′) output from the BG/UCR part 4a are temporarily stored in the memory 5. The image signals stored in the memory 5 are output to the color information analyzing part 8 for determining a parameter suitable for subsequent processes performed by the below-described γ correcting part (printer γ correcting part) 6 and the dither processing part 7.

Since the operation performed by the color analyzing part 8 is substantially the same as the one shown in FIG. 8 of the first embodiment, further explanation thereof is omitted. The determination operation of the color information analyzing part 8 is shown in FIG. 9. In a case where the values of both the Y signal and the C signal are other than 0, the color information analyzing part 8 outputs a j signal whose value is 1. In a case where the value of either or both the Y signal and the C signal is 0, the color information analyzing part 8 outputs a j signal whose value is 0.

When the Y parameter setting part 9 receives a j signal output from the color information analyzing part 8, the Y parameter setting part 9 sets Y parameters in the γ correcting part 6 and the dither processing part 7 in accordance with the received j signal. As shown in FIG. 10, one of the two sets of parameters being stored beforehand in the Y parameter setting part 9 is set to the γ correcting part 6 and the dither processing part 7 in accordance with the determination results from the color information analyzing part 8. FIG. 11 is a table for describing the operation of the Y parameter setting part 9.

Since the color information analyzing part 8 and the Y parameter setting part 9 operate in correspondence with each pixel, one of the two parameter combinations including the γ table and the dither matrix is selected and applied to each pixel in accordance with the determination result. Meanwhile, since the operation of selectively applying the γ table and the dither matrix is not performed with respect to the other remaining three colors of C, M, and K, the γ correction process and the dither process (half toning process) for the remaining three colors (C, M, K) are performed by applying predetermined γ tables and dither matrixes (dither process) corresponding to each of the remaining three colors (C, M, K).

Then, after the γ correction process and the half toning process are completed, output image data 10 are output from the image processing apparatus 2 to the image forming apparatus 50 via the optical laser unit 23. Thereby, a hard copy image of the output image data 10 is formed on the recording sheet 32.

Although the above-described operation of selectively switching the dither process according to the fifth embodiment is performed on color Y (Yellow), the operation may alternatively be performed on colors such as C (Cyan) or M (Magenta).

Next, the dither process (dither matrix) according to the fifth embodiment of the present invention is described in further detail. After the above-described dithering process is performed on an image, the dithered image has a dot periodic structure. That is, as shown in FIG. 18, a dither matrix referred to as dot screen dither is used in the dithering process (In the fifth embodiment, the dot screen is preferred as the dither matrix). In one example where the dither matrix has a periodic structure shown in FIG. 18, the screen angle and the screen line number (number of lines per inch, lpi) are uniquely obtained from the computation formula shown in FIG. 18. As described above, a two dimensional periodic structure is expressed by using two two-dimensional vectors (the main vector and the sub-vector).

Table 3 shows a combination of dither matrices (for four colors Y, C, M, K) according to the fifth embodiment of the present invention in a case where the main vector and the sub-vector shown in FIG. 18 are used.

TABLE 1

| | lines per | angle | | | | |
|---|---|---|---|---|---|---|
| | inch (lpi) | (deg.) | a0x | a0y | a1x | a1y |
| Y(dit1) | 145.5 | 14.0 | 4 | 1 | 1 | −4 |
| Y(dit2) | 145.5 | 76.0 | 1 | 4 | 4 | −1 |
| C | 145.5 | 14.0 | 4 | 1 | 1 | −4 |
| M | 145.5 | 76.0 | 1 | 4 | 4 | −1 |
| K | 141.4 | 45.0 | 3 | 3 | 3 | −3 |

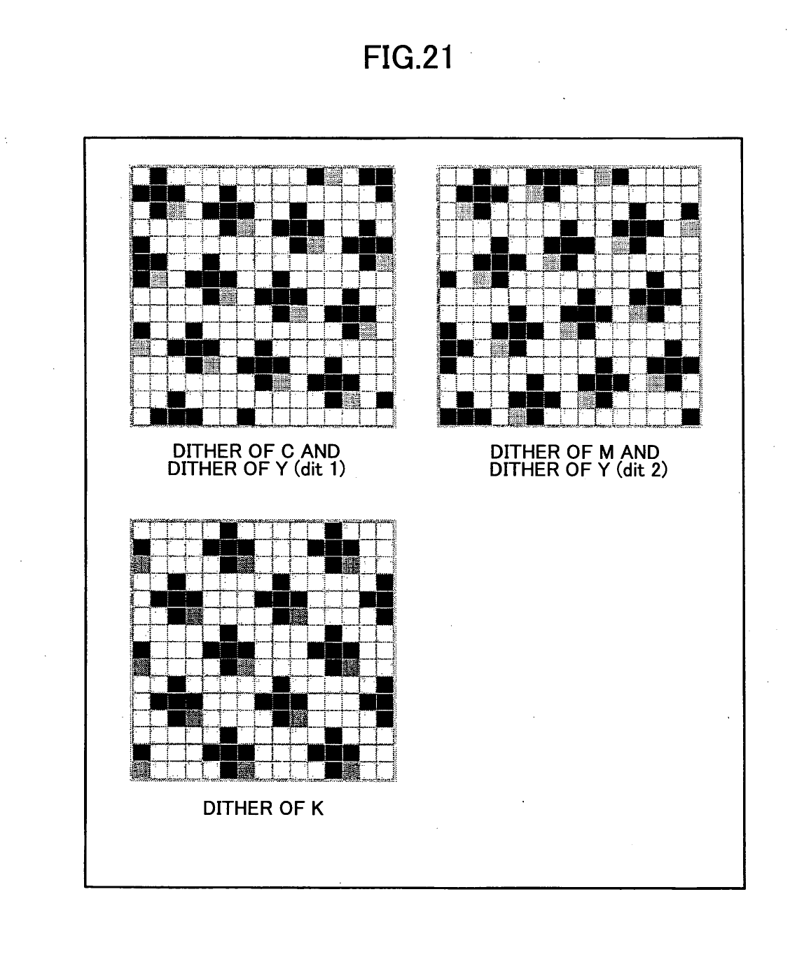

The four integers of a0x, a0y, a1x, and a1y shown in Table 3 correspond to the x component of the main vector, the y component of the main vector, the x component of the sub-vector, and the γ component of the sub-vector, respectively, in FIG. 18. Since the resolution is 600 dpi in the fifth embodiment of the present invention, it can be understood that the number of lines shown in Table 3 can be provided by obtaining the periodic structure indicated in Table 3. FIG. 21 shows the actual periodic structures of the dither matrices of Table 3. As shown in Table 3, the two types of dither matrices (dit 1, dit 2) for Y according to the fifth embodiment of the present invention are set so that their screen line number (lpi) and screen angle match with those of the dither matrices for C and M.

The combination of dither matrices is not limited to that shown in Table 3. As long as the screen line number and the screen angle of the two dither matrices (dit1 and dit2) for Y match with those of the dither matrices for C and M, combinations of dither matrices other than that of Table 3 may also be used.

After the above-described dithering process is performed on the image data, the image data become 4 bit dither matrices comprising 4 bits (16 values). The 4 bit dither matrix converts each pixel of input image data (8 bit data expressed in 256 levels (0-255)) to output image data (expressed in 16 levels (0-15)). In the conversion, the level (0-15) of each pixel of the input image data is determined by comparing the gradation level of each pixel of the input image data (256 levels) and a threshold level that is set beforehand with respect to the above-described 16 levels. In other words, the 4 bit dither matrix comprises 15 matrices being set with a predetermined threshold.

In the fifth embodiment of the present invention, although the quantization value in the above-described dithering process is 4 bits (16 values), other quantization values may alternatively be employed. For example, 1 bit, 2 bits, or 8 bits. Furthermore, the quantization values may also be 3 values or 5 values. The effects attained are substantially the same even in cases where different quantization values are used.

[Sixth Embodiment]

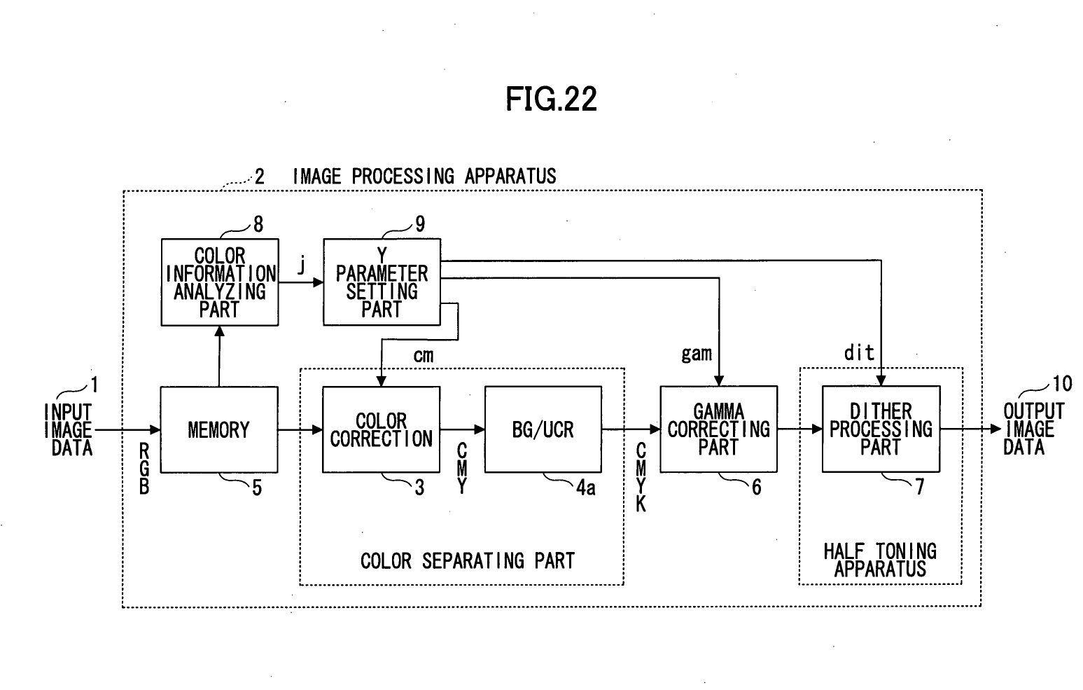

FIG. 22 shows an exemplary configuration of an image processing apparatus according to the sixth embodiment of the present invention. Throughout the descriptions and drawings of the sixth embodiment of the present invention, like components are denoted by like reference numerals as of the above-described embodiments of the present invention and are not further explained. In the fifth embodiment, the color information analyzing process is performed on image signals after the image signals are subjected to the BG/UCR process (Black Generating Process/Under Color Removing Process). That is, the color information analyzing process is performed based on color separated image signals (C, M, Y, K). Meanwhile, in the sixth embodiment, the color information analyzing process is performed on image signals before the image signals are subjected to the color correcting process and the BG/UCR process (Black Generating Process/Under Color Removing Process).

As shown in FIG. 22, the color correction part (color correction circuit) 3 and the BG/UCR part (BG/UCR circuit) 4a in the sixth embodiment are in a position following the color information analyzing part 8. The configurations of the color correction part 3 and the BG/UCR part 4a are the same as those shown in FIG. 19. The color information analyzing part 8 of the sixth embodiment also outputs determination results (j signals) in correspondence with C signals and Y signals.

In accordance with the j signals received from the color information analyzing part 8, the Y parameter setting part 9 outputs a color correction parameter cm for the color correcting part 3, a γ table gam for the γ correcting part 6, and a dither matrix dit for the dither processing part 7.

With the configurations of the first and fifth embodiments, colors that are different from those expected by the user are sometimes reproduced due to the switching process of the dither matrix for Y. However, with the configuration of the sixth embodiment, the color correction parameter cm of the color correcting part 3 can also be changed by the dither parameter set by the parameter setting part 9 according to the sixth embodiment. Therefore, an image can be created with satisfactory color reproduction performance even in a case where the dither screen is switched.

[Seventh Embodiment]

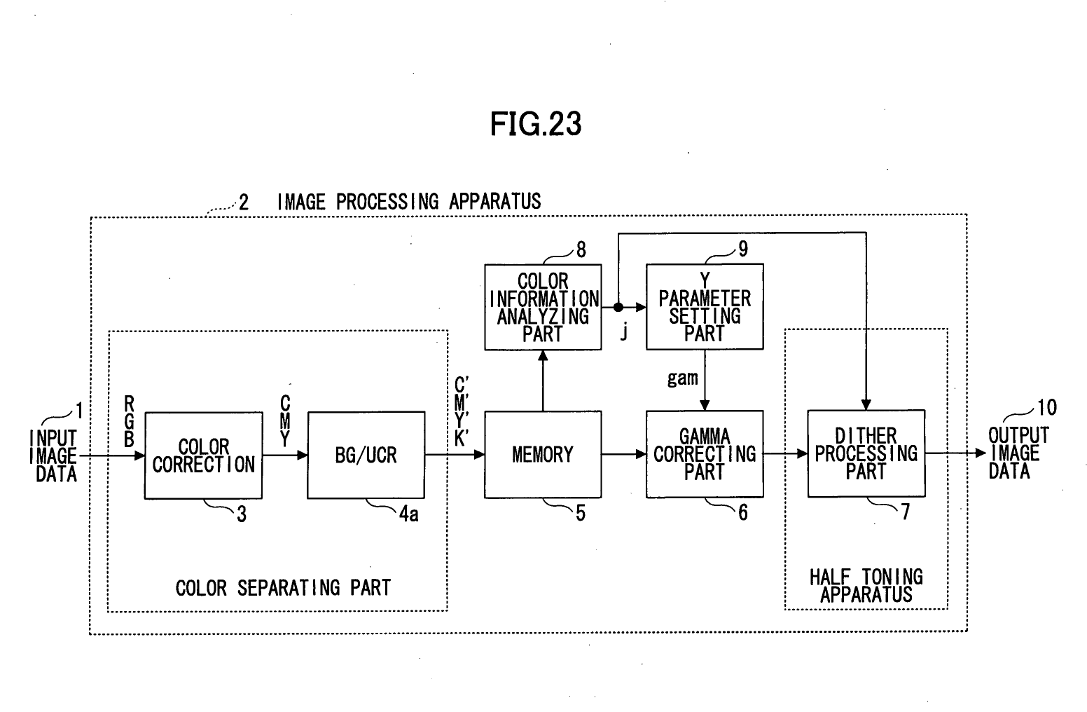

FIG. 23 shows an exemplary configuration of an image processing apparatus according to the seventh embodiment of the present invention. Most parts of the configuration of the seventh embodiment are the same as those of the fifth embodiment. Throughout the descriptions and drawings of the seventh embodiment of the present invention, like components are denoted by like reference numerals as of the fifth embodiment and are not further explained. The configuration of the seventh embodiment is different from the configuration of the fifth embodiment in that the dither processing part 7 receives the determination results (j signals) directly from the color information analyzing part 8 and switches the dither matrix used for Y to a dither matrix used for C or M (See FIG. 23).

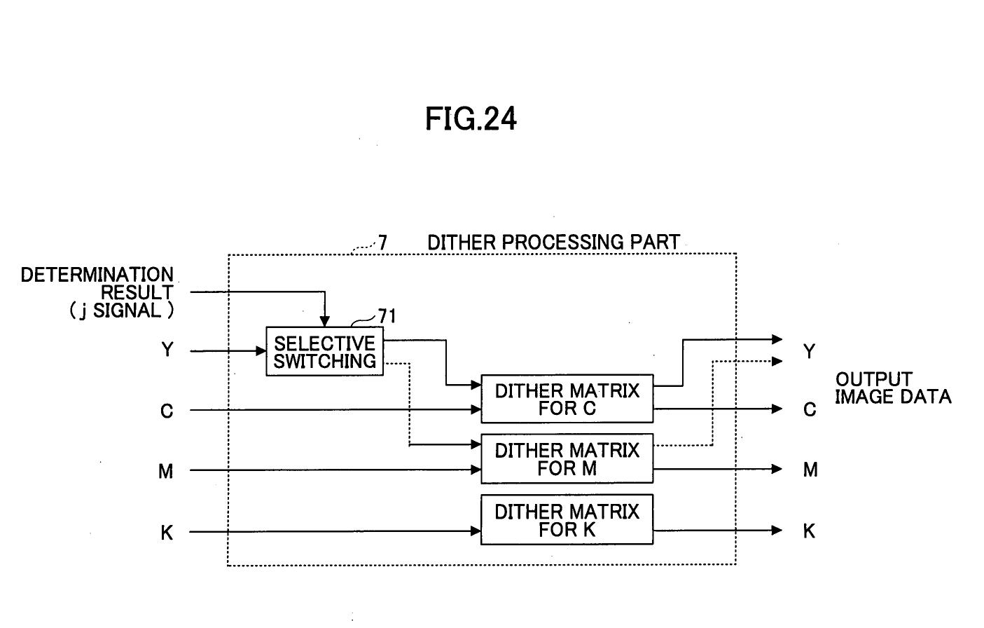

FIG. 24 is a schematic diagram showing a dither processing part 7 according to the seventh embodiment of the present invention. The dither processing part 7 is configured to switch the dither matrix to be applied to a Y signal. In a case where the value of the j signal is 1 (i.e. a case where the values of both the Y signal and the C signal are other than 0), the dither matrix used for M is applied to the Y signal. In a case where the value of the j signal is 0 (i.e. a case where either one or both of the Y signal and the C signal is 0), the dither matrix used for C is applied to the Y signal.

Since the configuration of the seventh embodiment uses no dither matrix dedicated for the Y signal, the memory space for storing the dither matrix dedicated for the Y signal is unnecessary. Therefore, the cost for memory space can be reduced.

[Eighth Embodiment]

Although a dot screen dithering process employing a dot-like periodic structure is used as the dithering process of the fifth embodiment of the present invention, a line screen dither process employing a linear periodic structure is used as the dither process of the eighth embodiment of the present invention.

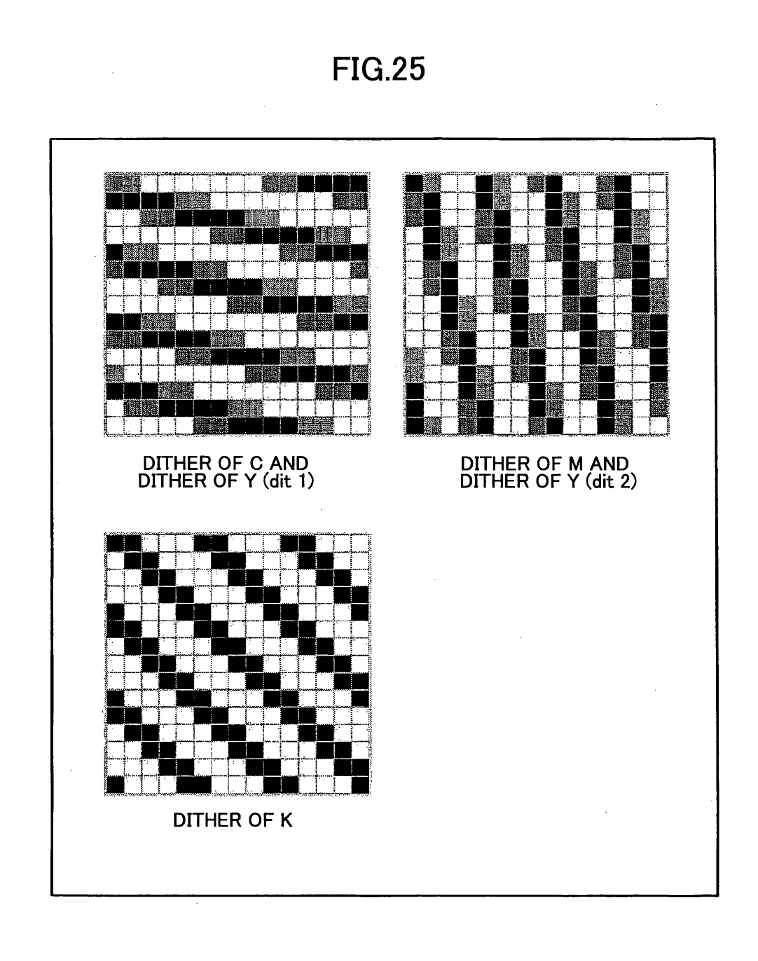

Table 4 shows a combination of dither matrices (for four colors Y, C, M, K) according to the eighth embodiment of the present invention in a case where the main vector and the sub-vector shown in FIG. 25 are used.

TABLE 2

| | lines per | angle | | | | |
|---|---|---|---|---|---|---|
| | inch (lpi) | (deg.) | a0x | a0y | A1x | a1y |
| Y(dit1) | 145.5 | 14.0 | 4 | 1 | 1 | −4 |
| Y(dit2) | 145.5 | 76.0 | 1 | 4 | 4 | −1 |
| C | 145.5 | 14.0 | 4 | 1 | 1 | −4 |
| M | 145.5 | 76.0 | 1 | 4 | 4 | −1 |
| K | 141.4 | 45.0 | 3 | 3 | 3 | −3 |

FIG. 25 shows the dither patterns corresponding to Table 4 according to the eighth embodiment of the present invention. The same as the dot screen dithering process, the line screen dithering process can express a periodic structure of dither by using periodic vectors (main vector, sub-vector). The relationships between the periodic vectors, the screen line number, and the screen angle is shown in FIG. 12.

[Ninth Embodiment]

In the color separation operation of the fifth embodiment, CMY signals are generated by using Formulas 2 and 3 so that the value of one of the C,M,Y becomes 0. In the ninth embodiment, the color separation operation is executed by using Formula 3 with respect to a light side (i.e. in a case where the value of Min (C,M,Y) is low in Formula 2). Meanwhile, the so-called UCA process (Under Color Addition) is executed with respect to a dark side (i.e. in a case where the value of Min (C,M,Y) is high in Formula 2).

More specifically, the values of CMY are determined by the below-described Formula 4.
C′=C−K/β4+(K−KT)/β4*β5
M′=M−K/β4+(K−KT)/β4*β5
Y′=Y−K/β4+(K−KT)/β4*β5 (Formula 4)

The Formula 4 is applied in a case where a relationship of K≧KT is satisfied, and the Formula 3 is applied in a case where a relationship of K≦KT is satisfied. That is, Formula 3 is applied in a case where the value of K is low (light area), and Formula 4 is applied in a case where the value of K is high (dark area). The third term in Formula 4 corresponds to the under color addition (UCA) process.

In the ninth embodiment, color separation is executed by using Formula 3 so that one of the colors of CMY becomes 0 when the lightness of the output image is within the range of 100-50. Meanwhile, color separation is partially executed by using Formula 4 when the lightness of the output image is within the range of 50-0. Accordingly, each color of CMY has a value when lightness ranges between 50-0. More specifically, since the color data of CMYK are 8 bit data (256 gradation data), the above-described configuration can be realized by setting KT so that the color separation operation switches from Formula 3 to Formula 4 when a relationship of Min (C,M,Y)=approximately 128 is satisfied.

[Comparative Experiment]

Next, a comparative experiment conducted by the inventors of the present invention is described. This comparative experiment relates to the relationship between the shape factor of the toner (SF-2, described below) and color moire generated between color Y and colors CMK. Although the comparative experiment was performed between Y and each one of C, M, and K, the result of the experiment performed between Y and K is described below since there was no significant difference between C, M, and K. Various toner samples having different shape factors SF-2 were prepared by changing the manufacturing conditions of the toners. Accordingly, color moire between Y and K was evaluated by using the toner samples.

With respect to the order of superposing the toner images in this comparative experiment, a K toner image was superposed on a Y toner image formed on an intermediary transfer member. Furthermore, the line screen number (lpi) and the screen angle for Y in the experiment were 166.4 lpi and 33.7 degrees, respectively. The line screen number (lpi) and the screen angle for K in the experiment were 150.0 lpi and 0.0 degrees.

Next, the shape factor of the toner according to an embodiment of the present invention is described. Shape factors such as SF-1 and SF-2 are used as indexes for expressing the shape of a toner particle. Since the method for calculating the shape factor is disclosed, for example, in Japanese Laid-Open Patent Application No. 2004-334092 and further explanation thereof is omitted. The shape factor according to an embodiment of the present invention is expressed by using SF-2. Various toner samples having different shape factors SF-2 were prepared in conducting the comparative experiment. SF-2 is an index in which the shape of a target toner particle is close to that of a sphere, the shape having substantially no concavo-convexo areas on its surface when the value of SF-2 is 100. As the value of SF-2 becomes greater than 100, the shape of the toner becomes more dissimilar to a sphere and more concavo-convexo areas appear on the surface of the toner. In the experiment, a test-purpose image outputting apparatus including the configuration of the fifth embodiment (Imagio Neo C600 (manufactured by Ricoh) modified for executing an image forming process in accordance with the above-described superposing order, toner conditions, and dither conditions) was used. Color moire was visually observed and evaluated on a graded scale of 1 to 5 (unsatisfactory to satisfactory). In evaluating the color moire between Y and K, images were output onto patches in gradations of 16 levels from the test-purpose apparatus. The color moire was evaluated by rating the patches of 16 levels using the graded scale and obtaining the average of the ratings. The ratings of graded scale are qualitatively expressed as follows.
Rank 5: Color moire unrecognizable
Rank 4: Color moire recognizable when carefully observed
Rank 3: Color moire recognizable to some degree
Rank 2: Color moire conspicuously recognizable
Rank 1: Color moire recognizable to a degree regarded to be abnormal

The below-described Table 5 shows the average of the ratings of the 16 level patches.

TABLE 5

| | | Evaluation Result |
|---|---|---|
| | Shape Factor | (Average Color |
| Type of Toner | (SF-2) | Moire Rating) |
| Polymerization 1 | 105 | 3.00 |
| Polymerization 2 | 120 | 3.20 |
| Polymerization 3 | 130 | 3.90 |
| Grinding 1 | 150 | 4.70 |

According to the results shown in Table 5, color moire occurs more when the value of the shape factor (SF-2) is low. Furthermore, a satisfactory average color moire rating of 4.7 can be attained when the toner manufactured by a grinding method has a shape factor of 150. Meanwhile, the average color moire ratings are unsatisfactory when the value of the shape factor (SF-2) is 130 or less. Accordingly, a significant effect can be attained in a case where the value of the shape factor of the toner is low and the shape of the toner is close to a sphere. Since a greater screen angle difference between color Y and the other colors CMK can be obtained with the present invention, spatial frequency would not be significantly recognized even where color moire is generated. Accordingly, a spherical toner which easily generates color moire may be used for the present invention. The toner of the four colors is desired to have a volume average particle size D that satisfies the relationship 3.0 μm≦D≦7.0 μm. That is, by setting the volume average particle size D to satisfy the relationship D≦7.0 μm, satisfactory granularity can be attained for the toner. Furthermore, by setting the volume average particle size D to satisfy the relationship of 3.0 μm≦D, a stable output image can be provided for a long period (thereby preventing the problem of carrier spent toner).

The functions of the above-described image processing apparatus may be executed through a recording medium on which a program code of software is recorded for causing a system or an apparatus to conduct such functions when the recording medium is loaded into and read out by a computer (e.g. CPU, MPU) of the apparatus or system. In this case, the functions are executed by the program code read out from the recording medium.

The recording medium on which the program code is recorded includes, for example, a flexible disk, a hard disk, an optical disk, a magneto-optical disk, a magnetic tape, a non-volatile memory card, and a ROM.

Furthermore, the functions not only can be executed by the program code read out by the computer, but may also be entirely or partly executed by an operating system (OS) of the computer according to the instructions from the program code.

Furthermore, the program code read out from the recording medium may be written onto a memory of an expanded function board or an expanded function unit connected to a computer so that the CPU in the expanded function board or the expanded function board can entirely or partly executed the functions in according to the instructions from the program code.

Further, the present invention is not limited to these embodiments, but variations and modifications may be made without departing from the scope of the present invention.

The present application is based on Japanese Priority Application Nos. 2005-168053 and 2005-271057 filed on Jun. 8, 2005 and Sep. 16, 2005, with the Japanese Patent Office, the entire contents of which are hereby incorporated by reference.

What is claimed is:

1. An image processing apparatus comprising:
a color separating apparatus for converting input image data into C,M,Y data, generating K data from the C, M, Y data, separating the K data into Bk data and Lk data, and generating C′,M′,Y′ data by conducting color conversion on any two of the C,M,Y data; and
a dither processing apparatus for selectively applying one of two dither matrices to one of the C′,M′,Y′ data in accordance with the color of an output image, and applying a predetermined dither matrix having a periodic structure that matches the periodic structure of one of the selectively applied dither matrices to the other two of the C′,M′,Y′ data.

2. The image processing apparatus as claimed in claim 1, wherein the periodic structures of the two dither matrices have the same numerical value.

3. The image processing apparatus as claimed in claim 1, wherein the data to which the two dither matrices are selectively applied are Y′ data.

4. The image processing apparatus as claimed in claim 1, wherein the selectively applied dither matrices have a linear periodic structure.

5. An image processing apparatus comprising:
a color separating apparatus for converting input image data into C,M,Y data, generating K data from the C, M, Y data, separating the K data into Bk data and Lk data, and generating C′,M′,Y′ data by conducting color conversion on any two of the C,M,Y data; and
a dither processing apparatus for selectively applying one of two dither matrices to one of the C′,M′,Y′ data in accordance with the color of an output image.

6. The image processing apparatus as claimed in claim 5, wherein the periodic structures of the two dither matrices have the same numerical value.

7. The image processing apparatus as claimed in claim 5, wherein the data to which the two dither matrices are selectively applied are Y′ data.

8. The image processing apparatus as claimed in claim 5, wherein the selectively applied dither matrices have a linear periodic structure.

9. An image processing apparatus comprising:
a color separating apparatus for converting input image data into C,M,Y data, generating K data from the C, M, Y data, and generating C′,M′,Y′ data by conducting color conversion on any two of the C,M,Y data; and
a dither processing apparatus for selectively applying one of two dither matrices to one of the C′,M′,Y′ data in accordance with the color of an output image, and applying a predetermined dither matrix having a periodic structure that matches the periodic structure of one of the selectively applied dither matrices to the other two of the C′,M′,Y′ data.

10. The image processing apparatus as claimed in claim 9, wherein the periodic structures of the two dither matrices have the same numerical value.

11. The image processing apparatus as claimed in claim 9, wherein the data to which the two dither matrices are selectively applied are Y′ data.

12. The image processing apparatus as claimed in claim 9, wherein the selectively applied dither matrices have a linear periodic structure.

13. The image processing apparatus as claimed in claim 9, wherein the generation of C′,M′,Y′ data by conducting color conversion on any two of the C,M,Y data are executed when the lightness of the output image is within a range of 100-50.

14. An image processing apparatus comprising:
a color separating apparatus for converting input image data into C,M,Y data, generating K data from the C, M, Y data, and generating C′,M′,Y′ data by conducting color conversion on any two of the C,M,Y data; and
a dither processing apparatus for selectively applying one of two dither matrices to one of the C′,M′,Y′ data in accordance with the color of an output image.

15. The image processing apparatus as claimed in claim 14, wherein the periodic structures of the two dither matrices have the same numerical value.

16. The image processing apparatus as claimed in claim 14, wherein the data to which the two dither matrices are selectively applied are Y′ data.

17. The image processing apparatus as claimed in claim 14, wherein the selectively applied dither matrices have a linear periodic structure.

18. The image processing apparatus as claimed in claim 14, wherein the generation of C′,M′,Y′ data by conducting color conversion on any two of the C,M,Y data are executed when the lightness of the output image is within a range of 100-50.

19. An image forming apparatus for forming multicolor images on a paper, the image forming apparatus comprising:
the image processing apparatus claimed in claim 1.

20. An image forming apparatus for forming multicolor images on a paper, the image forming apparatus comprising:
the image processing apparatus claimed in claim 5.
